(19) United States
(12) Patent Application Publication
(10) Pub. No.: US 2024/0013758 A1
(43) Pub. Date: Jan. 11, 2024

(54) MUSIC DATA ANALYSIS APPARATUS AND METHOD USING TOPOLOGICAL DATA ANALYSIS, AND MUSIC DATA GENERATION APPARATUS USING THE SAME

(71) Applicant: POSTECH Research and Business Development Foundation, Pohang-si (KR)

(72) Inventors: Jae Hun JUNG, Seongnam-si (KR); Chang Bom PARK, Hongseong-gun (KR); Dong Jin LEE, Pohang-si (KR); Mai Lan TRAN, Pohang-si (KR)

(73) Assignee: POSTECH Research and Business Development Foundation, Pohang-si (KR)

(21) Appl. No.: 18/200,477

(22) Filed: May 22, 2023

(30) Foreign Application Priority Data
May 20, 2022 (KR) 10-2022-0062199

(51) Int. Cl. G10H 1/00

(52) U.S. Cl. CPC G10H 1/0025; G10H 2210/145; G10H 2210/111; G10H 2250/311

(57) ABSTRACT

Disclosed are a music data analysis apparatus capable of analyzing and visualizing creation principles of music and a music data generation apparatus capable of using the creation principles. The music data generation apparatus may comprise: a memory; and a processor executing at least one instruction stored in the memory, wherein the processor is configured to perform: generating a seed overlap matrix so that the seed overlap matrix represents musical features of seed music data; and generating new music data based on the seed overlap matrix.

### CROSS-REFERENCE TO RELATED APPLICATIONS

This application claims priority to Korean Patent Application No. 10-2022-0062199, filed on May 20, 2022, with the Korean Intellectual Property Office (KIPO), the entire contents of which are hereby incorporated by reference.

### BACKGROUND

### 1. Technical Field

The present disclosure relates to a technique for analyzing music data and generating/composing music data, and more specifically, to a technique for analyzing structural principles of music data by applying a topological data analysis (TDA) technique and a technique for composing music data conforming to the structural principles.

### 2. Related Art

Personalized media has recently led to an increased demand for software or tools that can easily compose music. Such automatic composition techniques are typically implemented using artificial neural networks or similar methods. However, because these techniques only output results with patterns similar to learned music data, they may often neglect the principles and basic rules of music composition.

The majority of composition techniques using artificial neural networks involve taking input from video or text unrelated to music, extracting the main features or keywords from the input, and generating music data based on previously composed music that matches the mood or style of the features or keywords. Therefore, these methods do not greatly emphasize a difference from previously composed music and only provide a slight variation in order to avoid copyright issues.

As a result of recent researches, a method has been proposed in a Korean registered patent KR 10-1886534 titled ‘Composition system and composition method using artificial intelligence’. The method involves receiving a user input requesting a specific style of composition, acquiring information on chord progressions from a plurality of learning target sound sources, performing machine learning based on the information on chord progressions, and configuring a harmony progression of music using an artificial neural network obtained as a result of the machine learning.

While the method described above has improved by utilizing different chord progression information for each music style, it is questionable whether the essential principles of music composition have been fully grasped by simply categorizing chord progression information into several types.

### SUMMARY

An objective of the present disclosure is to provide an apparatus and a method for analyzing structural principles of music data by applying a topological data analysis technique. In addition, an objective of the present disclosure is to provide an apparatus and a method for visualizing the analyzed structural principles.

An objective of the present disclosure is to provide an apparatus and a method for automatically composing music data conforming to structural principles by analyzing the structural principles of music data and using at least one of a rule-based scheme/algorithm or an artificial neural network.

An objective of the present disclosure is to mathematically identify creation principles permeated in music genres that are generally difficult to access, for example, Korean traditional music data, and to visualize the composition principles of Korean traditional music based thereon. In addition, an objective of the present disclosure is to define a probability model based on the creation principles of Korean traditional music, or to provide a methodology for composing Korean traditional music by learning mathematical expressions of Korean traditional music.

An objective of the present disclosure is to analyze and visualize the music composition principles, to visualize the composition principles by using a probability model or symbols for users who want to learn music, and to support efficient learning of the music composition principles.

According to a first exemplary embodiment of the present disclosure, a music data analysis apparatus may comprise: a memory; and a processor executing at least one instruction stored in the memory, wherein the processor is configured to perform: transforming music data to a network including nodes and edges; obtaining cycle information by applying topological data analysis to the transformed network; and generating an overlap matrix representing musical features of the music data by calculating a distribution of cycles included in the cycle information.

The processor may be further configure to visualize the musical features of the music data based on the overlap matrix.

In the obtaining of the cycle information, the processor may be further configured to perform: applying a persistent homology theory linked to topological data analysis to the network to generate persistence barcode information; and obtaining the cycle information corresponding to patterns appearing within the music data by applying topological data analysis to the persistent barcode information.

In the generating of the overlap matrix, the processor may be further configured to perform: calculating the distribution of the cycles appearing in s consecutive sequences to generate the overlap matrix.

The processor may be further configured to perform: generating the nodes corresponding to notes appearing in the music data, and configuring a pitch and a length of each corresponding note in each node as information of the each node; and configuring an edge between the nodes, and configuring a frequency of the nodes appearing at a same time or adjacent time as information of the edge.

The processor may be further configured to perform: extracting a pattern repeatedly appearing within the music data as the cycle.

According to a second exemplary embodiment of the present disclosure, a music data generation apparatus may comprise: a memory; and a processor executing at least one instruction stored in the memory, wherein the processor is configured to perform: generating a seed overlap matrix so that the seed overlap matrix represents musical features of seed music data; and generating new music data based on the seed overlap matrix.

The processor may be further configured to perform: generating nodes each of which corresponds to a pitch and a length of a corresponding note within the seed music data; and generating the new music data by arranging the nodes at position(s) of at least one first note in the new music data to conform to a rule of the seed overlap matrix.

The processor may be further configured to perform: generating a node pool by overlapping the nodes based on a frequency of occurrence of the nodes and a target length; and generating the new music data by arranging nodes extracted based on probabilities from the node pool at position(s) of at least one second note in the new music data.

The music data generation apparatus may further comprise a generative artificial neural network having learned generative functions, which is stored in at least one of the memory or a data base, wherein the processor is further configured to perform: controlling the generative artificial neural network so that the seed overlap matrix is input to the generative artificial neural network; and controlling the generative artificial neural network so that the generative artificial neural network generates the new music data using the seed overlap matrix as an input.

According to a third exemplary embodiment of the present disclosure, a music data analysis method performed by a processor executing at least one instruction stored in a memory may comprise: transforming music data to a network including nodes and edges; obtaining cycle information by applying topological data analysis to the transformed network; and generating an overlap matrix representing musical features of the music data by calculating a distribution of cycles included in the cycle information.

The music data analysis method may further comprise: visualizing the musical features of the music data based on the overlap matrix.

The obtaining of the cycle information may further comprise: applying a persistent homology theory linked to topological data analysis to the network to generate persistence barcode information; and obtaining the cycle information corresponding to patterns appearing within the music data by applying topological data analysis to the persistent barcode information.

The generating of the overlap matrix may further comprise: calculating the distribution of the cycles appearing in s consecutive sequences to generate the overlap matrix.

According to an exemplary embodiment of the present disclosure, structural principles of music data can be analyzed by applying a topological data analysis technique. In addition, an exemplary embodiment of the present disclosure can visualize the analyzed structural principles.

An exemplary embodiment of the present disclosure can analyze structural principles of music data and automatically compose music data conforming to the structural principles by using at least one of a rule-based scheme/algorithm or an artificial neural network.

The present disclosure can mathematically identify creation principles permeated in music genres that are generally difficult to access, for example, Korean traditional music data, and based thereon, the present disclosure can visualize composition principles of Korean traditional music. In addition, it is possible to suggest a methodology for composing Korean traditional music by defining a probability model based on the creation principles of Korean traditional music or learning mathematical expressions of Korean traditional music.

According to the present disclosure, by analyzing and visualizing the composition principles of music, visualization of the composition principles can be provided to users who want to learn music through a probability model or symbols, and efficient learning of the composition principles of music can be supported for the users.

### BRIEF DESCRIPTION OF DRAWINGS

FIG. 1 is an operational flowchart illustrating a music data analysis method performed by a music data analysis apparatus according to an exemplary embodiment of the present disclosure.

FIG. 2 is a diagram illustrating a topological data analysis process performed by a music data analysis apparatus according to an exemplary embodiment of the present disclosure.

FIG. 3 is a process of extracting a node having a pitch and a length of a note from music data such as Suyeonjang, Songkuyeo, and Taryong, which is performed by a music data analysis apparatus according to an exemplary embodiment of the present disclosure.

FIGS. 4 and 5 illustrate frequency data of nodes appearing in music data such as Suyeonjang, Songkuyeo, and Taryong, which is obtained by a music data analysis apparatus according to an exemplary embodiment of the present disclosure.

FIG. 6 is a graph illustrating a process of obtaining cycles based on barcodes appearing in Suyeonjang music data, which are obtained during topological data analysis performed by a music data analysis apparatus according to an exemplary embodiment of the present disclosure.

FIG. 7 is a graph visualizing information on 8 cycles appearing in Suyeonjang music data, which is obtained during topological data analysis performed by a music data analysis apparatus according to an exemplary embodiment of the present disclosure.

FIG. 8 is a graph visualizing a distribution of cycles appearing in Suyeonjang music data, which is obtained during topological data analysis performed by a music data analysis apparatus according to an exemplary embodiment of the present disclosure.

FIG. 9 is a diagram illustrating information on nodes included in a cycle appearing in Suyeonjang music data, which is obtained during topological data analysis performed by a music data analysis apparatus according to an exemplary embodiment of the present disclosure.

FIG. 10 is a diagram illustrating that cycle information actually appears in Suyeonjang music data during topological data analysis performed by a music data analysis apparatus according to an exemplary embodiment of the present disclosure.

FIG. 11 is a graph illustrating an overlap matrix representing a distribution of cycles appearing in Suyeonjang music data, which is obtained during topological data analysis performed by a music data analysis apparatus according to an exemplary embodiment of the present disclosure.

FIGS. 12A and 12B are diagrams illustrating information on all nodes appearing in Suyeonjang music data, which is obtained during topological data analysis performed by a music data analysis apparatus according to an exemplary embodiment of the present disclosure.

FIGS. 13A and 13B are graphs illustrating a distribution of nodes appearing in Suyeonjang music data within a cycle, which is obtained during topological data analysis performed by a music data analysis apparatus according to an exemplary embodiment of the present disclosure.

FIG. 14 is a graph illustrating a process of obtaining cycles based on barcodes appearing in Songkuyeo music data, which are obtained during topological data analysis performed by a music data analysis apparatus according to an exemplary embodiment of the present disclosure.

FIG. 15 is a graph visualizing information on 8 cycles appearing in Songkuyeo music data, which is obtained during topological data analysis performed by a music data analysis apparatus according to an exemplary embodiment of the present disclosure.

FIGS. 16A to 16C are graphs illustrating a distribution of cycles appearing in Songkuyeo music data, overlapping matrix, and a distribution of nodes appearing in Songkuyeo music data within a cycle, which are obtained during the process of topological data analysis performed by a music data analysis apparatus according to an exemplary embodiment of the present disclosure.

FIG. 17 is a graph illustrating a process of obtaining cycles based on barcodes appearing in Taryong music data, which are obtained during topological data analysis performed by a music data analysis apparatus according to an exemplary embodiment of the present disclosure.

FIG. 18 is a graph visualizing information on 10 cycles appearing in Taryong music data, which is obtained during topological data analysis performed by a music data analysis apparatus according to an exemplary embodiment of the present disclosure.

FIG. 19 is a diagram illustrating that information on cycles actually appears in Taryong music data during topological data analysis performed by a music data analysis apparatus according to an exemplary embodiment of the present disclosure.

FIGS. 20A to 20C are graphs illustrating a distribution of cycles appearing in Taryong music data, overlap matrix, and a distribution of nodes appearing in Taryong music data within a cycle, which are obtained during the process of topological data analysis performed by a music data analysis apparatus according to an exemplary embodiment of the present disclosure.

FIG. 21 is an operational flowchart illustrating a music data generation method performed by a music data generation apparatus according to an exemplary embodiment of the present disclosure.

FIGS. 22 to 24 are diagrams illustrating a process of generating an integer overlap matrix, which is performed in a music data generation apparatus according to an exemplary embodiment of the present disclosure.

FIGS. 25 and 26 are diagrams illustrating a process of generating music data using an artificial neural network, which is performed in a music data generation apparatus according to an exemplary embodiment of the present disclosure.

FIG. 27 is a block diagram illustrating components constituting a music data analysis apparatus or a music data generation apparatus according to an exemplary embodiment of the present disclosure.

FIG. 28 is a block diagram illustrating components in a music data generating apparatus according to an exemplary embodiment of the present disclosure.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure may include, as part or all of its configuration, the computing system, the artificial intelligence neural network model, or other components used in constructing the composition system disclosed in the prior art presented above, namely the Korean registered patent KR 10-1886534 titled ‘Composition system and method using artificial intelligence’. In addition, the present disclosure may utilize basic principles of a topological data scheme presented in ‘Topology and data’ by Gunnar Carlsson, published in the Bulletin of the American Mathematical Society, volume 46, pages 255-308 in 2009, within a scope of the purposes of the present disclosure. Since those skilled in the art will be able to clearly infer the connection between the objectives and configurations of the present disclosure from the contents of the prior art documents, excessively detailed descriptions that may obscure the purpose of the present disclosure will be omitted, and the description is substitute by introducing the prior art documents.

Hereinafter, with reference to the accompanying drawings, preferred exemplary embodiments of the present disclosure will be described in more detail. In order to facilitate overall understanding in the description of the present disclosure, the same reference numerals are used for the same components in the drawings, and redundant descriptions of the same components are omitted.

In the present disclosure, exemplary embodiments for analyzing ‘Suyeonjangjigok’, ‘Songkuyeojigok’, and ‘Taryong’ will be disclosed. ‘Suyeonjangjigok’ may be expressed as ‘Suyeonjang’, and ‘Songkuyeojigok may be expressed as Songkuyeo’ afterward for convenience of description. Although exemplary embodiments of the present disclosure will be described with a focus on Korean traditional music, it is obvious to those skilled in the art that the analysis and generation techniques of the present disclosure are applicable to various music data including repeated patterns and patterns formed by overlapping nodes.

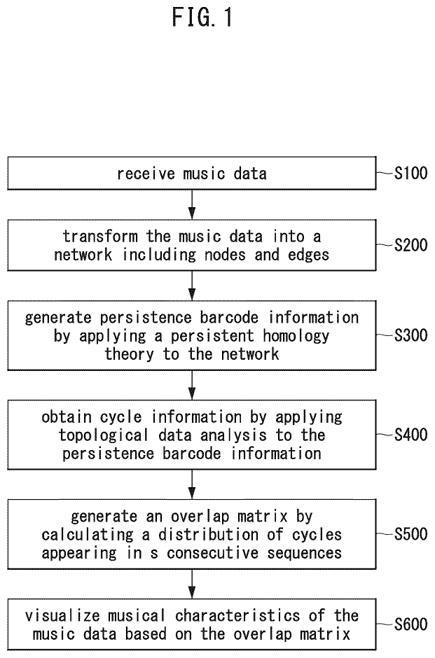

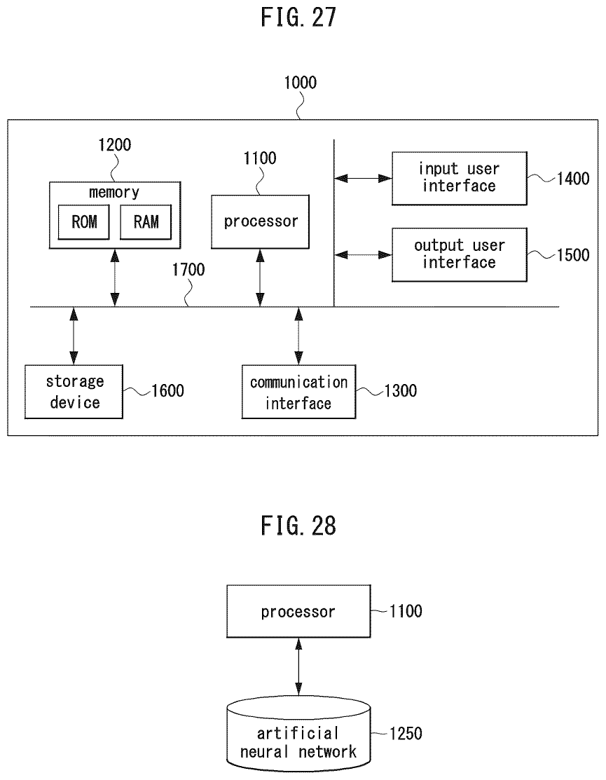

FIG. 1 is an operational flowchart illustrating a music data analysis method performed by a music data analysis apparatus according to an exemplary embodiment of the present disclosure. The music data analysis method performed by the music data analysis apparatus of FIG. 1 may be performed by a processor 1100 of FIG. 27 to be described later.

Referring to FIG. 1, the music data analysis apparatus according to an exemplary embodiment of the present disclosure may receive music data (i.e., score) (S100), and transform the music data into a network including nodes and edges (S200).

The music data analysis apparatus may obtain cycle information by applying topological data analysis to the transformed network (S400), and calculate a distribution of cycles included in the cycle information to generate an overlap matrix representing musical features of the music data (S500).

In generating the overlap matrix (S500), the music data analysis apparatus may generate the overlap matrix by calculating a distribution of cycles occurring in s consecutive sequences.

The music data analysis apparatus may visualize musical characteristics of the music data based on the overlap matrix (S600).

In order to obtain the cycle information (S400), the music data analysis apparatus may generate persistence barcode information by applying a persistent homology theory associated with topological data analysis to the network (S300), and may apply topological data analysis to the persistence barcode information to obtain the cycle information corresponding to patterns occurring within the music data (S400).

In order to transform the music data into the network (S200), the music data analysis apparatus may generate nodes corresponding to notes occurring within the music data, configure a pitch and a length of a note in the corresponding node as information of the node, configure edges between the nodes, and configure a frequency at which the nodes occur at the same time or adjacent times as information of the corresponding edge.

The music data analysis apparatus may extract a pattern that occurs repeatedly in the music data as a cycle, and may perform the steps S300 and S400 to obtain the cycle information.

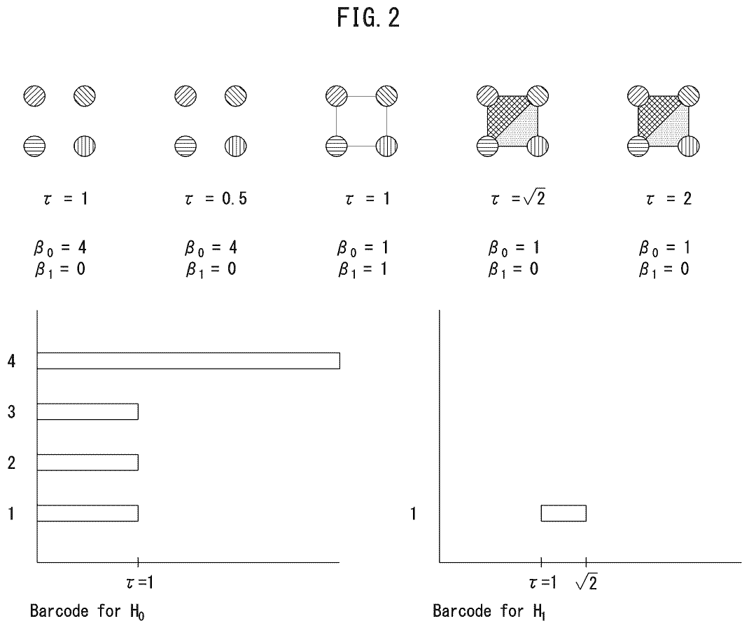

FIG. 2 is a diagram illustrating a topological data analysis process performed by a music data analysis apparatus according to an exemplary embodiment of the present disclosure.

The topological data analysis used in the exemplary embodiment of the present disclosure may use k-simplex, Betti number, and/or barcode analysis techniques. Since a concept and characteristics of the k-simplex, Betti number, and barcode analysis techniques used in the general topological data analysis can be understood by those skilled in the art with reference to a preceding literature ‘Topology and data’, Gunnar Carlsson, Bulletin of The American Mathematical Society, 46:255-308, 2009, a detailed description thereon will be omitted.

However, a barcode of FIG. 2 introduced in the present disclosure may be specialized to meet the objectives of the present disclosure.

FIG. 2 illustrates simple data comprising four music nodes. Referring to the upper part of FIG. 2, music nodes may be represented at vertexes of a unit square. When two nodes are randomly selected, the minimum distance therebetween may be 1 and the maximum distance may be the length of a diagonal of the unit square, i.e., \sqrt{2}. The Betti number may be defined for n-dimension, and the n-dimensional Betti number may be a generator of the n-th homology group.

The Betti number may be obtained by connecting the four nodes to each other with respect to a filtration parameter τ having several values. For example, possible Betti numbers when τ=0, 0.5, 1, \sqrt{2}, and 2 are shown in FIG. 2.

When the parameter τ=1, since all nodes are connected, there is only one connected component, and the connected nodes form a hole as shown in FIG. 2, zero-dimensional and one-dimensional Betti numbers may have values of β₀=1 and β₁=1, respectively.

When the parameter τ=\sqrt{2}, the square may be divided into two triangles, a hole may disappears by the nodes, and two filled triangles may appear. FIG. 2 shows the parameter τ having 5 values and zero-dimensional and one-dimensional Betti numbers for each parameter.

In the lower part of FIG. 2, the zero-dimensional and one-dimensional Betti numbers obtained for more parameters τ are shown. The horizontal axis of the lower graph in FIG. 2 may show the parameter τ, and the vertical axis thereof may show the Betti number. The lower graph of FIG. 2 may be understood as barcodes of the present disclosure for convenience of description. Since only one connected component remains when the parameter τ goes to infinity, this may be understood to mean that the length of the zero-dimensional fourth barcode goes to infinity. The lengths of the zero-dimensional first, second and third barcodes have a value of 1, and the length of the one-dimensional first barcode has a value of \sqrt{2}−1.

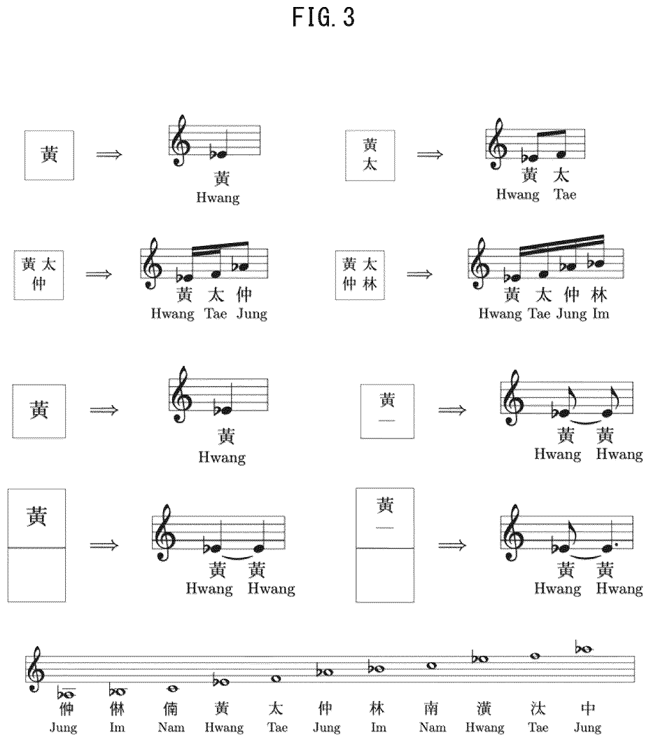

In an exemplary embodiment of the present disclosure disclosed in FIGS. 3 to 20 below, the music data may be a score, and may be Jeongganbo, a representative score representing Korean traditional music.

A process of obtaining an overlap matrix representing structural features of music using a topological data analysis technique from music data such as Suyeonjang, Songkuyeo, and Taryong expressed in Jeongganbo will be described through a number of exemplary embodiments. Unlike typical western music notation, in Jeongganbo, a pitch of each note may be encoder and a length thereof may be directly visualized in a matrix form. The present disclosure mainly focuses upon cycle structures. First, a unique and characterized node element may be defined according to a pitch and a length of a note in each music. The music may be represented as a graph by nodes and edges. A distance between nodes may be defined by an adjacent occurrence rate of the nodes. Two nodes may be considered close to each other if they occur frequently side-by-side.

The cycle information may be obtained by applying a persistent homology technique to the music data. The graph, in which a distance between nodes is used as a metric, may be used as a point cloud whose homological structure is investigated by measuring a hole structure in each dimension. The cycles representing the musical features of Jeongganbo may be identified, and how these cycles are interconnected with other cycles may be visualized.

One-dimensional homology may be obtained by applying a persistent homology to the point cloud. The characteristic patterns constituting the music may be obtained as the cycle information by the persistent homology analysis. A distribution and a frequency of the cycles may be obtained as an overlap matrix, and the musical features constituting the music may be visualized by visualizing the overlap matrix.

An efficient means for analyzing cycle structures or loop structures included within multi-dimensional data through the topological data analysis using persistent homology will be disclosed. In particular, the one-dimensional homology structure may be closely related to repeating patterns in music flow when a proper topological space is considered.

The music recorded in Jeongganbo is often referred to as ‘Jeong-Ak’ and is understood to represent an exemplary form of music of the Joseon dynasty.

In the present disclosure, focusing on the similarity of the music recorded in Jeongganbo to a kind of matrix form, how musical patterns having cyclical structures interact with each other according to a flow of Suyeonjang and Songkuyeo music may be analyzed, and a means for visualizing them may be derived. The musical features of Suyeonjang and Songkuyeo derived in the above-described manner may be compared with those of Taryong.

Songkuyeo has a very similar pattern to Suyeonjang, but is known to be one octave higher than Suyeonjang. Suyeonjang and Songkuyeo have unique musical structures known as ‘Dodeuri’. Dodeuri means ‘repeat-and-return’, and since Songkuyeo is one octave higher, it may be also called ‘upper Dodeuri’ and Suyeonjang is called ‘lower Dodeuri’. The simplest pattern of Dodeuri is a form of A-B-C-B, C-B in the second half may be a variation of A-B in the first half, and the part B is repeated in both the first and second halfs. The characteristics of Dodeuri pattern have been studied for a long time, but the present disclosure provides a method for analyzing the Dodeuri pattern occurring commonly in Suyeongjang and Songkuyeo by analyzing how their cyclical structures and repeated cycles interact in music flow.

It is also derived from the present disclosure that the cycles identified in Suyeonjang and Songkuyeo frequently overlap with each other, and that this form reflects the characteristics of Dodeuri, which is a special type of cyclical music found in Korean traditional music. On the other hand, in a type such as Taryong, which does not belong to the Dodeuri class, music cycles may appear individually. This difference may be understood to allow a listener to feel musical effects when a plurality of cycles appear simultaneously and overlap.

FIG. 3 is a process of extracting a node having a pitch and a length of a note from music data such as Suyeonjang, Songkuyeo, and Taryong, which is performed by a music data analysis apparatus according to an exemplary embodiment of the present disclosure.

In Jeongganbo, each column may be represented by 32, 16, 12 or 6 squares called ‘Jeonggan’. In Jeonggan, a pitch of a note is indicated by the first letter of each of the 12 Yulmyeong (i.e., Koran traditional music notes). As is known, the names of the 12 Yulmyeong are ‘Hwangjong’, ‘Daeryeo’, ‘Taeju’, ‘Hyeopjong’, ‘Goseon’, ‘Jungryeo’, ‘Yubin’, ‘Imjong’, ‘Ichik’, ‘Namryeo’, ‘Muyeok’, and ‘Eungjong’. Since only the first letters of the 12 Yulmyeong are displayed in the Jeonggan, only the first letters are shown in FIG. 3. The length of each note is determined according to the arrangement of the first letters of the Yulmyeong expressed in one Jeonggan, and an example of this may be shown in FIG. 3. Since one Jeonggan corresponds to a quarter note, if only one Yulmyeong is denoted in one Jeonggan, the note has the length of a quarter note, and if two Yulmyeong are denoted horizontally side by side in one Jeonggan, the notes each has the length of an eighth note. As shown in FIG. 3, there are several other options for changing a pitch or length of the note.

At the lower part of FIG. 3, 11 pitches used in Suyeonjang, Songkuyeo, and Taryong covered in the exemplary embodiments of the present disclosure are shown. In Suyeonjang, Songkuyeo, and Taryong, five notes are actually used: ‘Jung (G#3)’, ‘Im (A#3)’, ‘Nam (C4)’, ‘Hwang (D#4)’, and ‘Tae (F4)’. Since Jung (G#3) can be played two octaves high, and the remaining four notes can be played one octave higher, a total of eleven pitches 11 are shown, including a range of pitches they cause. In addition, in Suyeonjang and Songkuyeo, each column includes 6 Jeonggan, and in Taryong, each column includes 12 Jeonggan. The lengths of notes range from 1/6-Jeonggan to 6-Jeonggan.

In addition, there are ornamenting tones (i.e., kkumim-eums) due to the nature of Korean music in which various variations are given. The exemplary embodiments of the present disclosure show a case excluding the ornamenting tones, but the spirits of the present disclosure should not be limitedly interpreted by such the examples.

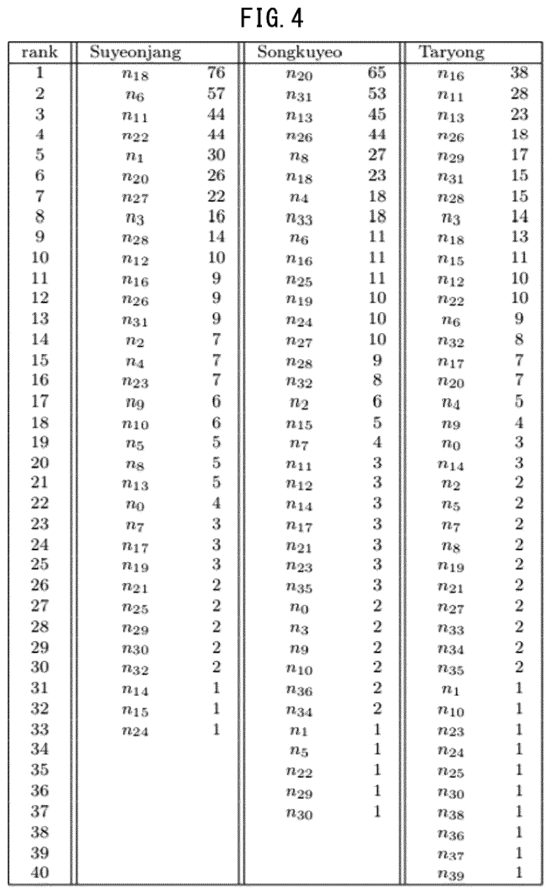

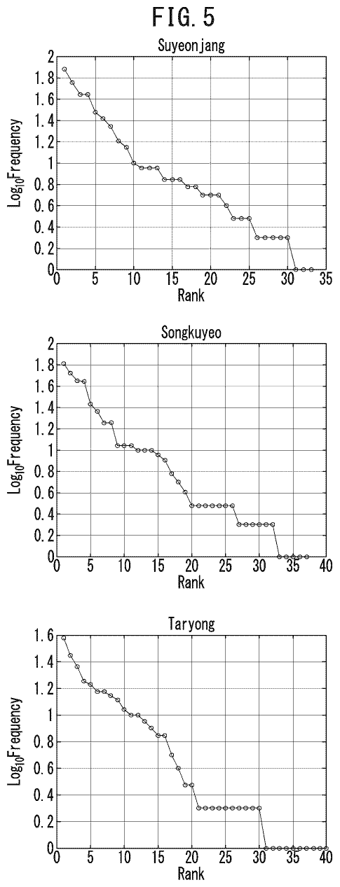

FIGS. 4 and 5 illustrate frequency data of nodes appearing in music data such as Suyeonjang, Songkuyeo, and Taryong, which is obtained by a music data analysis apparatus according to an exemplary embodiment of the present disclosure.

Each node may be defined by a pitch and length of a note. That is, it is given as ‘node=(pitch, length)’. The pitch and length of the note may be regarded as values of each node.

Referring to FIG. 4, it can be seen that there are 33 nodes in Suyeonjang, 37 nodes in Songkuyeo, and 40 nodes in Taryong. In FIG. 4, it can be seen that the most frequently appearing node in Suyeonjang appears 76 times, the most frequently appearing node in Songkuyeo appears 65 times, and the most frequently appearing node in Taryong appears 38 times.

The distribution of the nodes in FIG. 4 may be shown as in graphs of FIG. 5. The graphs of FIG. 5 show the frequencies of the nodes of Suyeonjang, Songkuyeo, and Taryong, respectively. The horizontal axis represents a rank of the frequencies of the respective nodes, and is shown in order from the most frequently appearing node. The vertical axis represents the frequency at which each node appears. FIG. 5 is shown on a semi-logarithmic scale. As shown in FIG. 5, the frequency at which the node appears decays more exponentially than algebraically within each music type.

When two nodes appear adjacent in time, the two nodes may be said to be connected. It may be assumed that an edge eᵢⱼ is defined between a node nᵢ and a node nⱼ. Here, i and j are natural numbers. The edge eᵢⱼ is an element of a set E. A weight or degree wᵢⱼ of the edge eᵢⱼ may be given as a frequency at which two nodes nᵢ and nⱼ occur adjacent to each other in time. For two different nodes nᵢ and nⱼ (i<j), pᵢⱼ may be defined as a path having the minimum number of edges between the nodes nᵢ and nⱼ found using a Dijkstra algorithm. In this case, if a distance dᵢⱼ between the two different nodes nᵢ and nⱼ for the two different nodes nᵢ and nⱼ (i<j) is defined as a reciprocal of the weight wᵢⱼ, a distance matrix D={dᵢⱼ} may be expressed by Equation 1 as follows.

$${d}_{ij} = \{ \begin{matrix}{\sum }_{{e}_{kl} ∈ {p}_{ij}} {w}_{kl}^{- 1} , & i < j \\ 0 , & i = j\end{matrix} and {d}_{ij} = {d}_{ji} , i > j , \qquad [ Equation 1 ]$$

Here, wₖₗ is a weight of an edge eₖₗ, and pᵢⱼ is an element of a union of exp.

According to Equation 1, pᵢⱼ may exist and dᵢⱼ may also be defined for two different nodes nᵢ and nⱼ (i<j) that are not directly connected to each other.

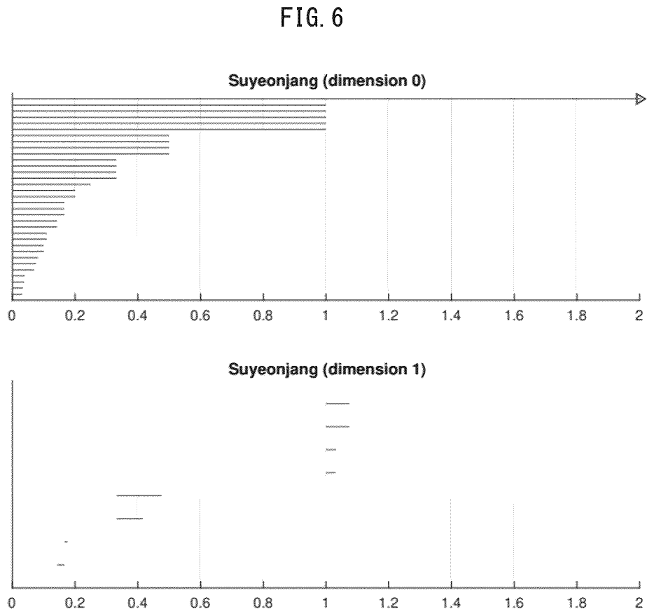

Hereinafter, in exemplary embodiments of FIGS. 6 to 20, a processes of obtaining nodes, obtaining cycle information, and obtaining an overlap matrix from a barcode graph by topological data analysis will be described, and an overlap matrix of each exemplary embodiment will be described so that the obtained musical feature information can be compared with each other.

FIG. 6 is a graph illustrating a process of obtaining cycles based on barcodes appearing in Suyeonjang music data, which are obtained during topological data analysis performed by a music data analysis apparatus according to an exemplary embodiment of the present disclosure.

Referring to FIG. 6, barcode information obtained from Suyeonjang music data by using Javaplex with Vietoris-Rips method is shown. By applying this method, a distance matrix based on mathematical distances of nodes may be obtained.

The graphs of FIG. 6 are zero-dimensional and one-dimensional barcode graphs, respectively. The horizontal axis of the graph of FIG. 6 represent a filtration parameter τ. The principle of illustrating the graphs of FIG. 6 is based on the barcode graph shown in FIG. 2. In the graph of FIG. 6, a plurality of intervals corresponding to generators of homology groups are shown in the vertical direction.

33 generators corresponding to 33 components are shown when the parameter τ is small in the zeroth dimension. The 33 generators may be connected into a single component when T=1. The 33 components may actually correspond to 33 nodes defined in Suyeonjang. According to the distances between nodes defined in Equation 1 above, since an arbitrary node is connected to another node at least once, the maximum distance between nodes may be given as d=1. The zero-dimensional barcode graph is interpreted as having this meaning.

In the one-dimensional barcode graph, 8 generators are shown. These 8 generators topologically correspond to 8 cycles. A relationship between these 8 cycles and the repetition of music melodies may be analyzed as follows.

A persistence algorithm for calculating intervals may be used to find a representative cycle of each interval. For example, annotated intervals calculated using the method computeAnnotatedIntervals in Javaplex may be related to what the nodes in the intervals of persistence are. In the case of one dimension, the annotated intervals may consist of components in the loops generated in the process of filtration.

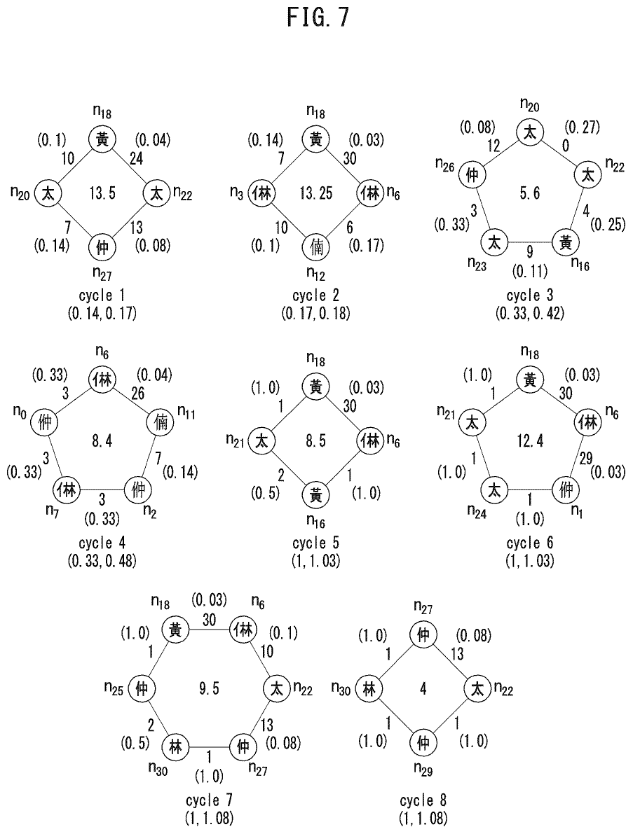

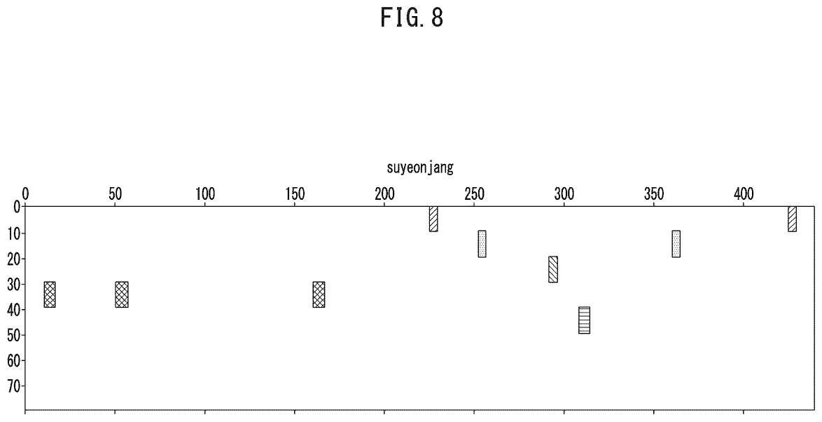

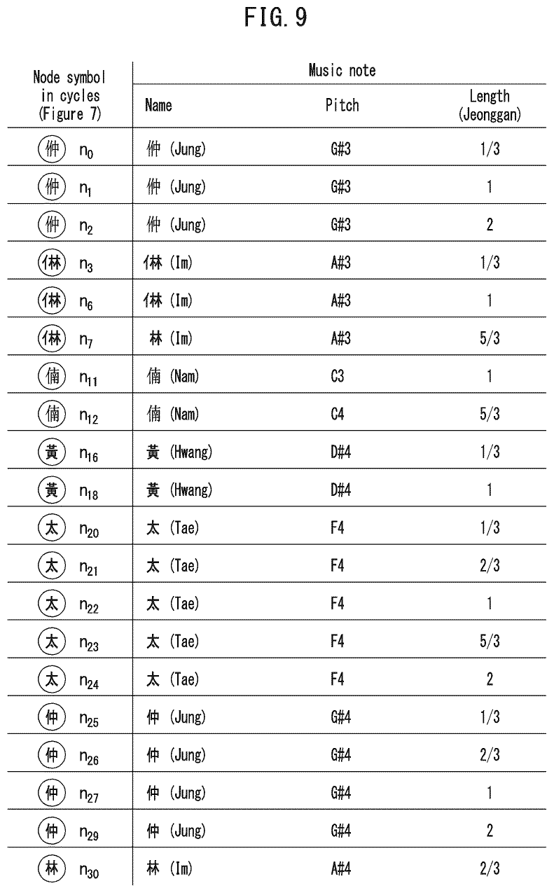

FIG. 7 is a graph visualizing information on 8 cycles appearing in Suyeonjang music data, which is obtained during topological data analysis performed by a music data analysis apparatus according to an exemplary embodiment of the present disclosure.

Referring to FIG. 7, 8 cycles identified by the topological data analysis process on the Suyeonjang music data are shown. For each cycle, a persistence interval, node information (its node number and note), edge weight, and distances between nodes are shown. A number shown in the center of each cycle may be an average weight. The average weight is a simple mean of weights of all edges constituting the cycle. The numbers of the nodes constituting each cycle shown in FIG. 7 may refer to FIG. 4.

The persistence interval of Cycle 1 may be [0.14, 0.17], the number of the node may be 1, and the weights of the respective edges may be 24, 13, 7, and 10 clockwise. The distances between nodes may be 0.04, 0.08, 0.14, and 0.1 clockwise, with an average weight of 13.5. The length of the persistence interval may be 0.03.

Cycle 2 is a cycle having the length (0.01) of the shortest persistence interval in the one-dimensional barcode graph of FIG. 6. Cycle 4 is a cycle having the length (0.15) of the longest persistence interval in the one-dimensional barcode graph of FIG. 6.

Among the 8 cycles of FIG. 7, a cycle with the smallest number of nodes may have 4 nodes, and a cycle with the largest number of nodes may have 6 nodes. The average of the number of nodes in the 8 cycles may be 4.625 and the average of the weights may be 9.39375.

A process of assigning cycle numbers corresponding to the persistence intervals appearing in the one-dimensional barcode graph of FIG. 6 may be performed based on the following criteria. 1) The order of cycles may be designated in the order in which the persistence intervals appear according to the size of the parameter value of the one-dimensional barcode graph. 2) A lower number may be assigned from a cycle of the one-dimensional barcode that disappears the earliest after appearing in the one-dimensional barcode graph. Depending on an exemplary embodiment, 1) and/or 2) may be applied together or sequentially. That is, the lowermost persistence interval of the one-dimensional barcode graph of FIG. 6 corresponds to Cycle 1 of FIG. 7, and the uppermost persistence interval corresponds to Cycle 8 of FIG. 7.

The order of the cycles in FIGS. 6 and 7 may be different from the order in which patterns appear in actual music.

Cycles 6, 7 and 8 do not appear as a complete series in actual music. The persistence intervals of Cycles 6, 7, and 8 may start at d=1 (τ=1) of the one-dimensional barcode graph.

FIG. 8 is a graph visualizing a distribution of cycles appearing in Suyeonjang music data, which is obtained during topological data analysis performed by a music data analysis apparatus according to an exemplary embodiment of the present disclosure.

Referring to FIG. 8, distributions in which Cycles 1, 2, 3, 4, and 5 appear based on the consecutive order of notes appearing in Suyeonjang music data are visualized. The horizontal axis represents a time sequence of music flow. The vertical axis represents intervals for classification of the cycles. An interval [0, 10] on the vertical axis is for Cycle 1, an interval [10, 20] on the vertical axis is for Cycle 2, and an interval [40, 50] on the vertical axis is for Cycle 5. Setting the height of each bar to 10 is to visually distinguish the cycles and has no other meaning. The width of each bar on the graph corresponds to the number of nodes included in each cycle. Referring to FIG. 8, it can be seen that Cycles 6, 7, and 8 among the cycles shown in FIGS. 6 and 7 do not actually appear in the music data. That is, these patterns may appear in topological data analysis but not in the time sequence of music flow.

FIG. 9 is a diagram illustrating information on nodes included in a cycle appearing in Suyeonjang music data, which is obtained during topological data analysis performed by a music data analysis apparatus according to an exemplary embodiment of the present disclosure.

Referring to FIG. 9, all nodes included in 8 cycles appearing in Suyeonjang music data are shown. A total of 33 nodes appear in Suyeonjang music data, and FIG. 9 shows 20 nodes appearing in 8 cycles among them. FIG. 9 shows the nodes arranged in a numerical order, and each node is differentiated from other nodes by a name, pitch, and length of a corresponding note.

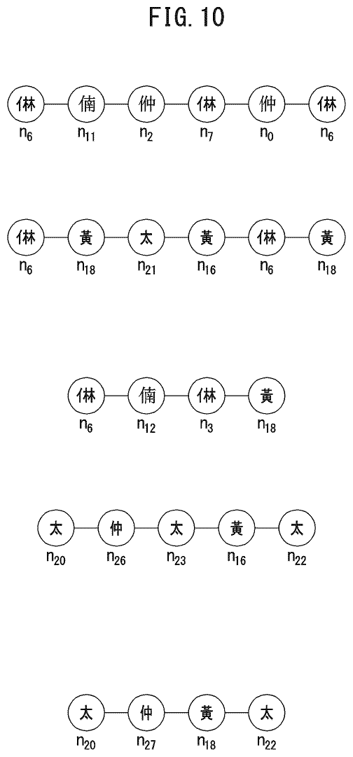

FIG. 10 is a diagram illustrating that cycle information actually appears in Suyeonjang music data during topological data analysis performed by a music data analysis apparatus according to an exemplary embodiment of the present disclosure.

FIG. 10 shows whether the cycle information derived from the one-dimensional barcode graph in FIG. 6 and introduced in FIG. 7 actually appears in the music data. Through this process, it was confirmed that Cycles 6, 7, and 8 do not actually appear in a completely continuous form within the music data.

Referring to FIG. 10, Cycle 4 continues with nodes n6, n11, n2, n7, n0, and n6 and appears on the actual music data three times. Cycle 5 consists of four nodes in FIG. 7 and appears once in the form of the nodes n6, n18, n21, n16, n6, and n18 on the actual music data. Cycles 4 and 5 make up closed cycles and appear on the time series of the actual music data.

Cycle 2 appears twice on the actual music data in the order of nodes n6, n12, n3, and n18, and Cycle 3 appears once in the order of nodes n26, n23, n16, and n22. It can be seen that Cycles 2 and 3 do not make up closed cycles on the time series of the actual music data, but they preserve the order of edge connectivity of the cycles.

In the case of Cycle 1, it appears twice in the order of nodes n20, n27, n18, and n22, which is slightly different from the order of edge connectivity shown in FIG. 7, on the time series of the actual music data. However, since all four nodes included in Cycle 1 of FIG. 7 are included, even in this case, Cycle 1 can be seen as appearing on the actual music data.

Referring again to FIGS. 8 and 10, regions marked with the same pattern (i.e., monotonicity thereof) in the graph of FIG. 8 mean that the sequence thereof is the same as the sequence of the cycle appearing within the music, and regions marked with different patterns (i.e., variation thereof) as in Cycle 4 mean that the sequence thereof is slightly different from the order of the cycle appearing within the music. In FIG. 8, Cycle 4 appears in the first half, and the remaining four cycles appear in the second half. In addition, since cycles rarely appear in complete form, it can be seen that the cycle information derived from structural information is not completely reproduced on the time series of the actual music data.

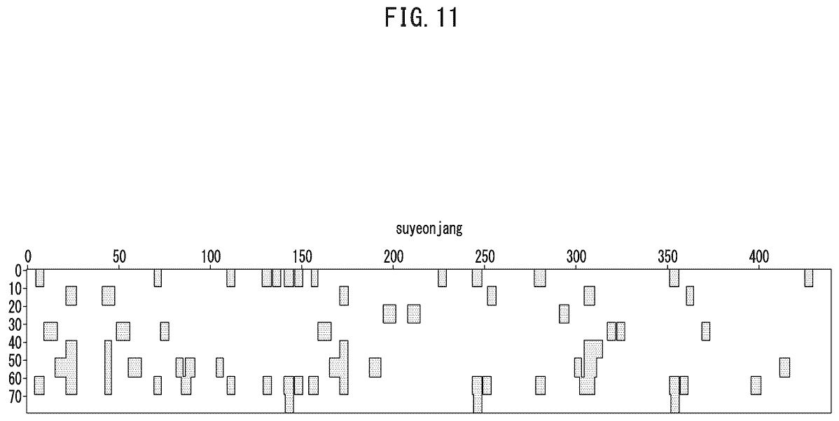

FIG. 11 is a graph illustrating an overlap matrix representing a distribution of cycles appearing in Suyeonjang music data, which is obtained during topological data analysis performed by a music data analysis apparatus according to an exemplary embodiment of the present disclosure.

For music data O having d notes flowing in the order of L={N₁, . . . , N_{d}}, an overlap matrix on s-scale for a positive integer s may be expressed as follows. It is assumed that k generators corresponding to k cycles C₁, . . . , and Cₖ can be obtained from the one-dimensional barcode graph of the music data O.

The overlap matrix M_{k×d}^{s} on s-scale for the music data O is a matrix whose elements are mᵢⱼ^{s}. It may be expressed as M_{k×d}^{s}={mᵢⱼ^{s}}, and the elements mᵢⱼ^{s} of the overlap matrix may be defined as in Equation 2 below.

$${m}_{ij}^{s} = \{ \begin{matrix}1 , & if ∃ t , l \geq 0 satisfying t + l \geq s - 1 such that \\ & {n}_{j - l} , {n}_{j - l - 1} , … , {n}_{j} , … , {n}_{j + t - 1} , {n}_{j + t} ∈ {C}_{i} , \\ 0 , & otherwise ,\end{matrix} \qquad [ Equation 2 ]$$

Equation 2 above may be defined for i=1, . . . , k, and j=1, . . . , d.

That is, the overlap matrix M_{k×d}^{s} is a binary matrix whose entries are either 0 or 1. It is a necessary and sufficient condition for the matrix M_{k×d}^{s} to belong to s-scale that any entry equal to 1 in each row of the matrix M_{k×d}^{s} should be staying in a consecutive sequence of length at least s columns that equal to 1. When the overlap matrix M_{k×d}^{s} is a matrix having a size corresponding to the number k of cycles and the total number d of notes of the music data, the node nⱼ is included in Cycle Cᵢ, and a combination of the node nⱼ, for which a consecutive sequence having at least a length of s is formed before or after, and Cycle Ci exists, it can be understood that the overlap matrix M_{k×d}^{s} belongs to s-scale.

FIG. 11 shows a 4-scale overlap matrix for Suyeonjang music data. FIG. 11 is similar to FIG. 8 in that cycles appear according to the music flow. However, FIG. 11 differs from FIG. 8 in that each cycle is displayed whenever at least four nodes within a cycle appear in music. The order may not be the same for each appearance. In FIG. 11, the cycles are observed more frequently than in FIG. 8. In FIG. 11, Cycles 6, 7, and 8 appear because the order of nodes is not strictly limited. Since Cycles 6, 7 and 8 do not appear in FIG. 8, the case of FIG. 11 can be compared with the case of FIG. 8. In the case of Cycle 6, it appears at a considerable frequency in FIG. 11. On the other hand, in FIG. 11, a plurality of cycles may be found at the same time.

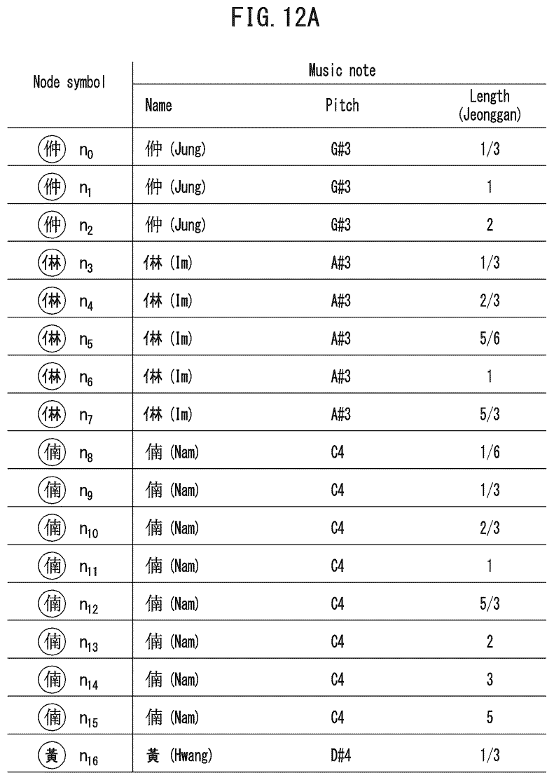

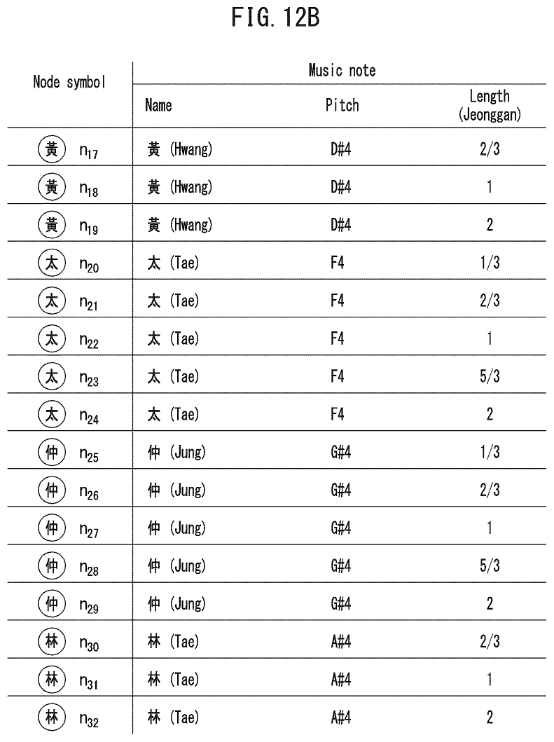

FIGS. 12A and 12B are diagrams illustrating information on all nodes appearing in Suyeonjang music data, which is obtained during topological data analysis performed by a music data analysis apparatus according to an exemplary embodiment of the present disclosure.

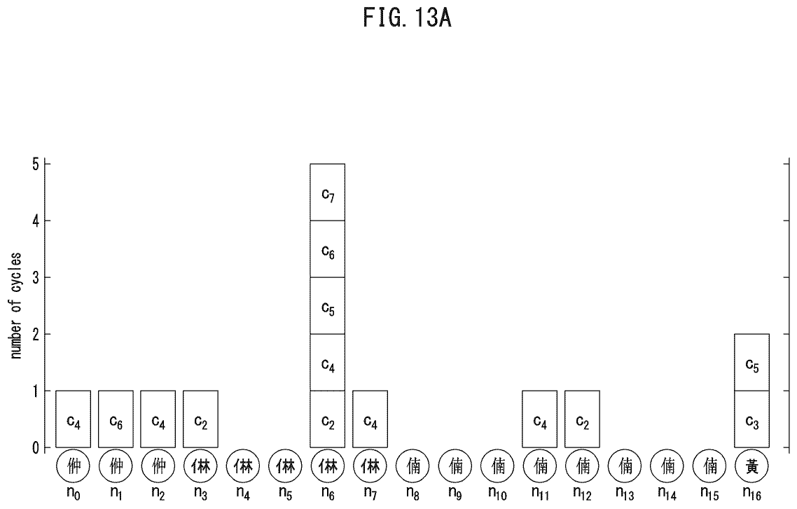

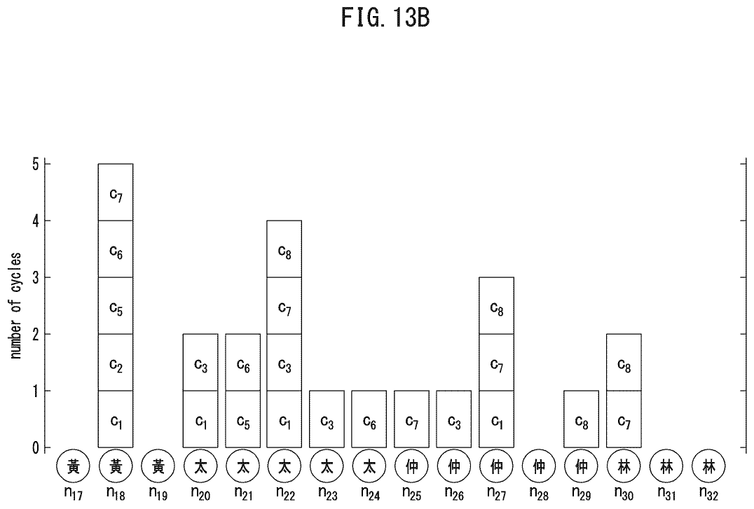

In FIGS. 12A and 12B, 33 nodes from nodes n0 to n32 are shown. As described above, only 20 nodes belonging to 8 cycles are shown in FIG. 9 among them. The fact that 20 nodes among 33 nodes belong to 8 cycles is shown in FIGS. 13A and 13B.

FIGS. 13A and 13B are graphs illustrating a distribution of nodes appearing in Suyeonjang music data within a cycle, which is obtained during topological data analysis performed by a music data analysis apparatus according to an exemplary embodiment of the present disclosure.

That is, FIGS. 13A and 13B are graphs showing how many cycles each node belongs to based on the 33 nodes appearing in the Suyeonjang music data. The horizontal axis represents all the 33 nodes in ascending order of pitch, and the vertical axis represents the total number of cycles and cycle numbers to which each node belongs. For example, the node n0 belongs to Cycle 4 (c₄), the node n1 belongs Cycle 6 (c₆), the node n2 belongs to Cycle 4 (c₄), the node n3 belongs to Cycle 2 (c₂), and so on. The nodes n4 and n5 do not belong to any cycle, and the node n6 belongs to 5 cycles (i.e., Cycle 2 (c₂), Cycle 4 (c₄), Cycle 5 (c₅), Cycle 6 (c₆) and Cycle 7 (c₇)).

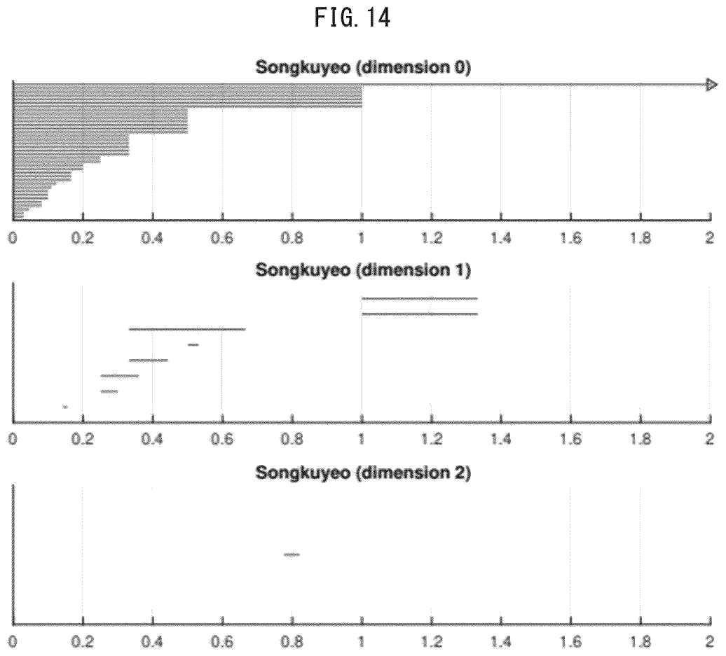

FIG. 14 is a graph illustrating a process of obtaining cycles based on barcodes appearing in Songkuyeo music data, which are obtained during topological data analysis performed by a music data analysis apparatus according to an exemplary embodiment of the present disclosure.

The barcode graph of FIG. 14 is similar to the barcode graph of the music data of FIG. 6, but is different in that FIG. 14 shows 0-dimensional, 1-dimensional and 2-dimensional barcode graphs. When the parameter τ=0, 37 components are observed. 37 is the same as the number of nodes used in Songkuyeo. In the one-dimensional barcode, 8 non-zero persistence intervals appear, and this is interpreted as 8 cycles appearing in Songkuyeo as in the case of Suyeonjang.

In FIG. 14, one persistence interval is observed in the 2-dimensional barcode graph. A void-like structure may be understood to appear in Songkuyeo. However, since the size of the persistence interval in this case is small, the size of void may be understood as small.

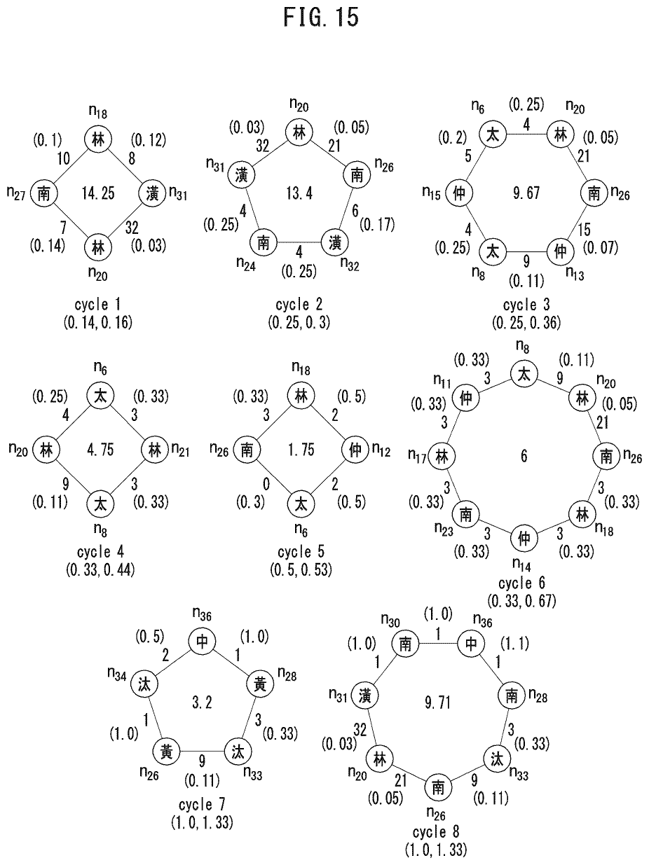

FIG. 15 is a graph visualizing information on 8 cycles appearing in Songkuyeo music data, which is obtained during topological data analysis performed by a music data analysis apparatus according to an exemplary embodiment of the present disclosure.

Referring to FIG. 15, the 8 cycles appearing in Songkuyeo are shown together with the persistence intervals, node information (node numbers, pitches of notes), edge weights, distance between nodes, and average values of weights of edges constituting each cycle.

Cycle 1 may correspond to the shortest persistence interval in the one-dimensional barcode graph. Cycle 6 may correspond to the longest persistence interval. Cycles 2, 3, 5, 6, 7 and 8 do not appear in their sequential form in the actual music. The persistence intervals of Cycles 7 and 8 may start at a point d=1 (τ=1) of the one-dimensional barcode. The average of the numbers of nodes in the 8 cycles is 5.375, which is greater than the average of the number of nodes in Suyeonjang, and the average of weights in the 8 cycles is 7.84125, which is smaller than the average of weights in Suyeonjang.

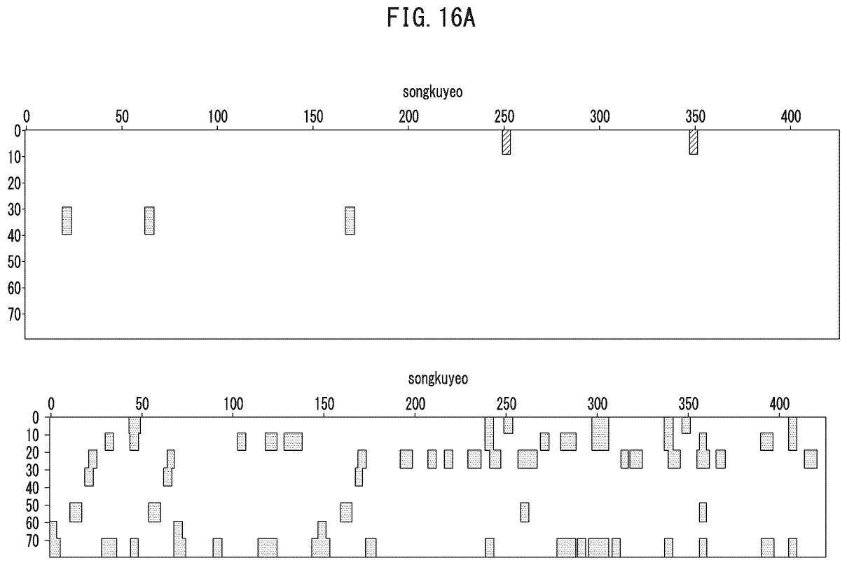

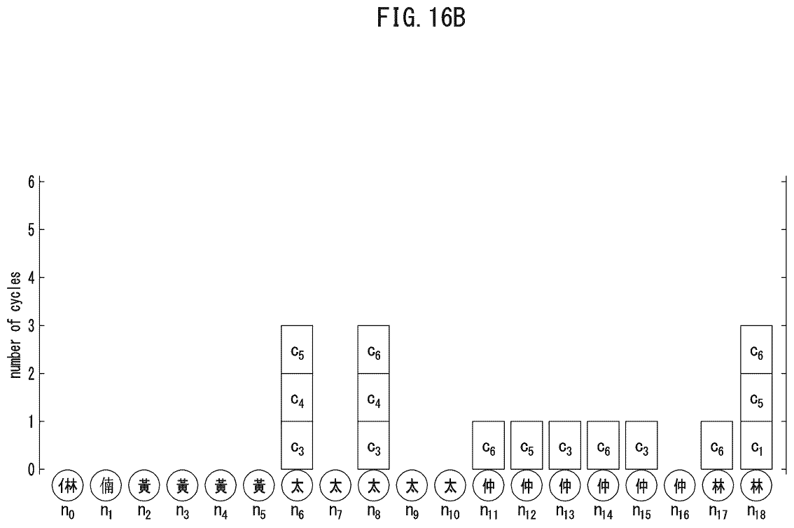

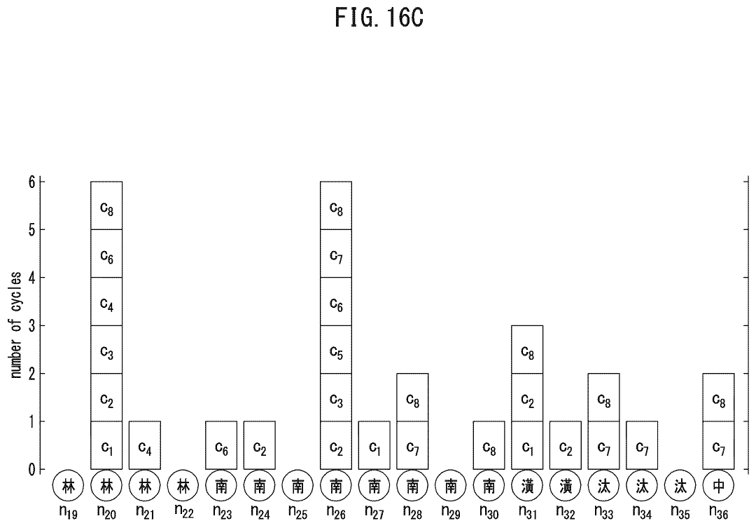

FIGS. 16A to 16C are graphs illustrating a distribution of cycles appearing in Songkuyeo music data, overlapping matrix, and a distribution of nodes appearing in Songkuyeo music data within a cycle, which are obtained during the process of topological data analysis performed by a music data analysis apparatus according to an exemplary embodiment of the present disclosure.

The sequence of consecutive notes corresponding to Cycles 1 and 4 that actually appear in Songkuyeo is shown at upper part of FIG. 16A. The horizontal axis is a time sequence according to the music flow, and the vertical axis represents intervals allocated to the respective cycles. An interval [0, 10] on the vertical axis corresponds to Cycle 1, and an interval [30, 40] on the vertical axis corresponds to Cycle 4. As in FIG. 8, a width of a bar indicated by each cycle may mean the number of nodes belonging to the cycle.

Cycle 4 appears in the first half of the music, and Cycle 1 appears in the second half of the music. Although 8 cycles appear in topological data analysis in Songkuyeo, a distribution of the cycles in actual music is rare.

In the lower part of FIG. 16A, a 4-scale overlap matrix for Songkuyeo is shown. When at least 4 or more nodes in a cycle appear in association, they are represented in the overlap matrix, and thus many cycles appear compared to the graph at the upper part of FIG. 16A. However, Cycle 5 does not appear in the lower part of FIG. 16A. On the other hand, Cycle 4, which actually appears as a continuous sequence in music, appears only three times in the lower part of FIG. 16A. It is also found that a plurality of cycles appear simultaneously. The order may not be the same for each appearance.

The lower part of FIG. 16A shows which nodes are included in 8 cycles among 37 nodes included in Songkuyeo, how many times each node is included in which cycle, and the like. FIGS. 16B and 16C are illustrated according to a concept similar to the graph of FIG. 13 for Suyeonjang.

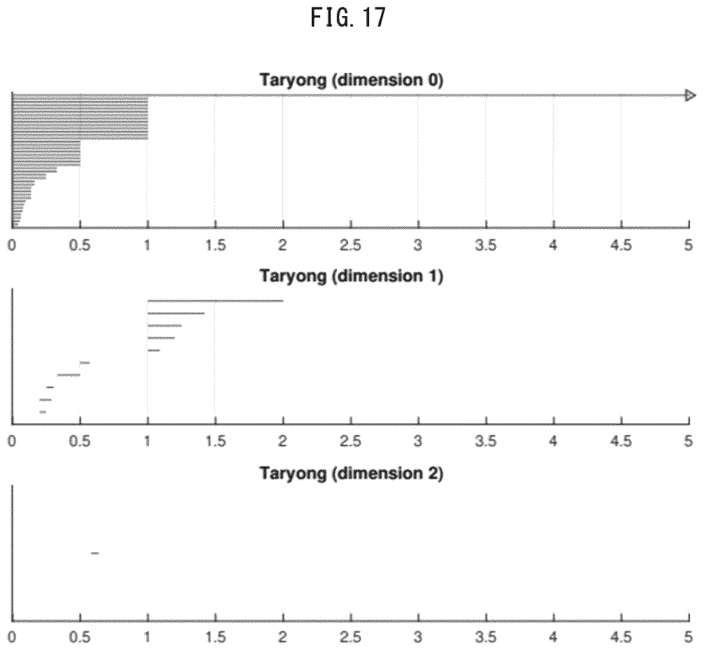

FIG. 17 is a graph illustrating a process of obtaining cycles based on barcodes appearing in Taryong music data, which are obtained during topological data analysis performed by a music data analysis apparatus according to an exemplary embodiment of the present disclosure.

The barcode graph of FIG. 17 is also obtained for Taryong music data using the Vietoris-Rips method. FIG. 17 also shows 0-dimensional, 1-dimensional, and 2-dimensional barcode graphs. It is understood that a two-dimensional persistence interval appearing in the two-dimensional barcode graph topologically corresponds to a two-dimensional void within a music network. In Taryong, 10 cycles are found in the one-dimensional barcode graph.

40 components corresponding to the 40 nodes used in Taryong appear in the 0-dimensional barcode graph. It can be seen that the 10 cycles appearing in Taryong are more than the 8 cycles appearing in Suyeongjang and Songkuyeo.

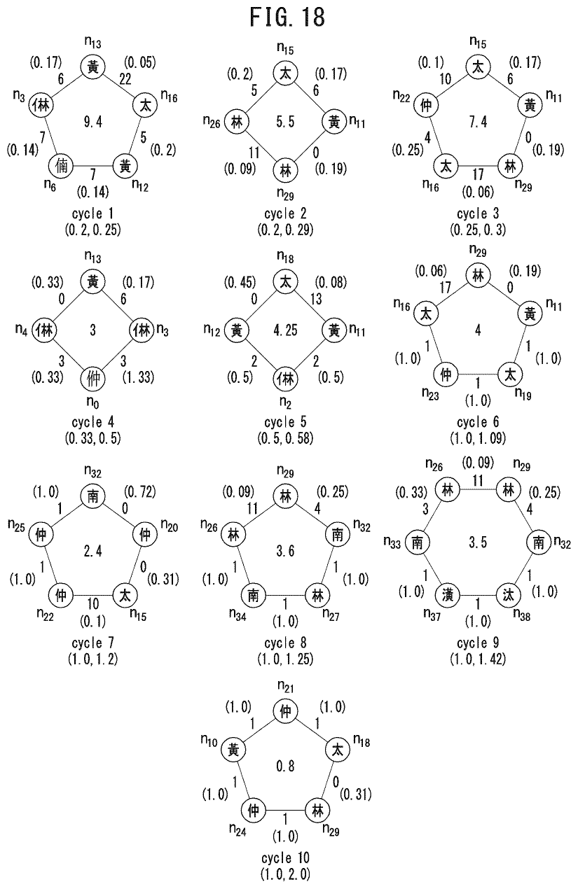

FIG. 18 is a graph visualizing information on 10 cycles appearing in Taryong music data, which is obtained during topological data analysis performed by a music data analysis apparatus according to an exemplary embodiment of the present disclosure.

Referring to FIG. 18, each of the 10 cycles is illustrated along with a persistence interval, node information (node number, note pitch), edge weights, distance between nodes, and average weight value.

Cycle 1 may correspond to the shortest persistence interval in the one-dimensional barcode graph of FIG. 17. Cycle 10 may correspond to the longest persistence interval in the one-dimensional barcode graph of FIG. 17. Cycles 2, 3, 7, and 8 do not appear in their sequential form in the actual music. The persistence intervals of Cycles 7 and 8 start from a point d=1 (τ=1).

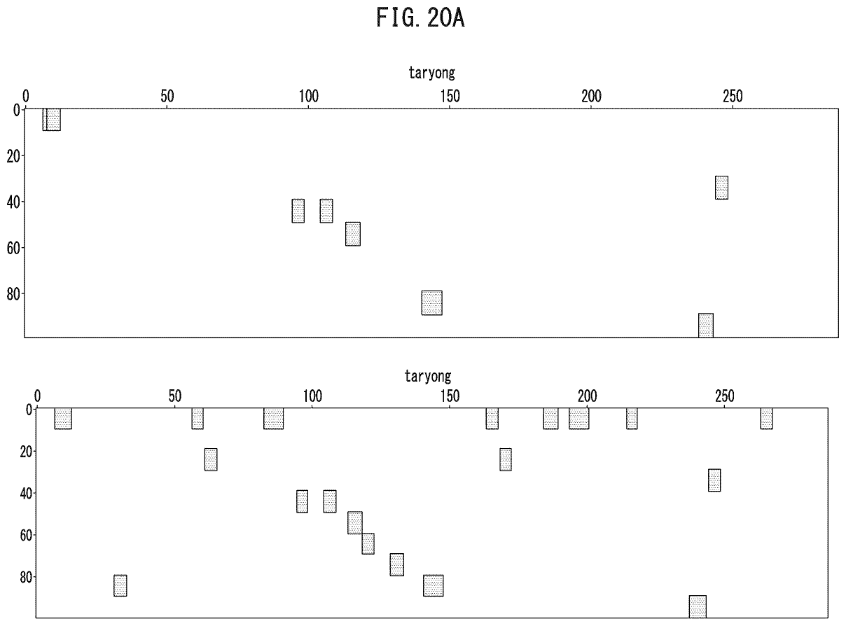

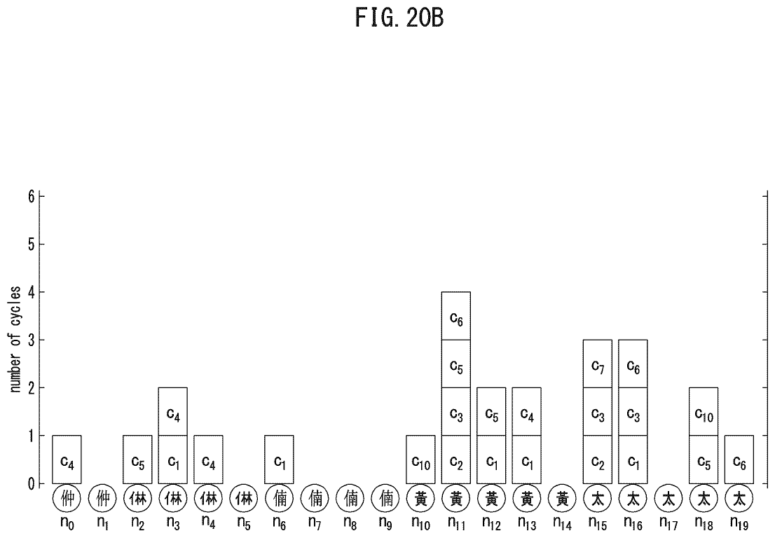

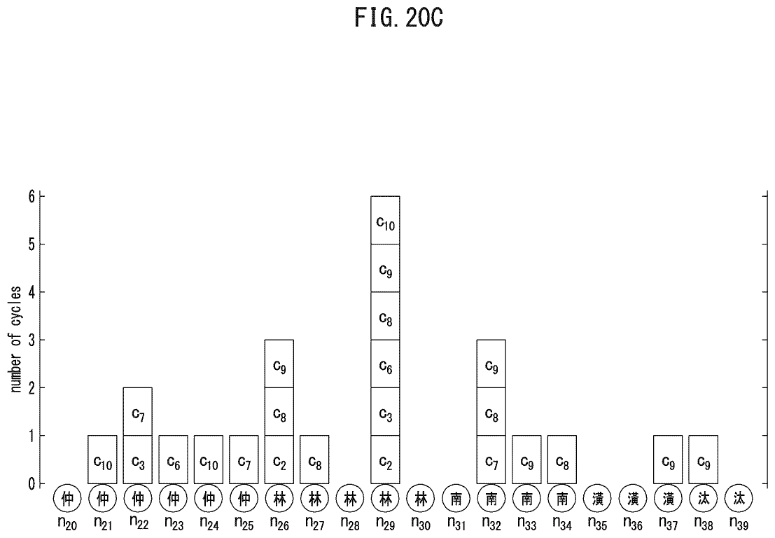

The average of the numbers of nodes of 10 cycles is 4.8 and the average of the weights is 4.385. It is observed that the number of cycles is higher in Taryong than Suyeongjang and Songkuyeo, but the average number of nodes is smaller. On the other hand, despite the large number of cycles, the number of appearances of cycles appearing in music is observed to be lower in Taryong than Suyeonjang and Songkuyeo. This is shown in FIG. 20 to be described later.

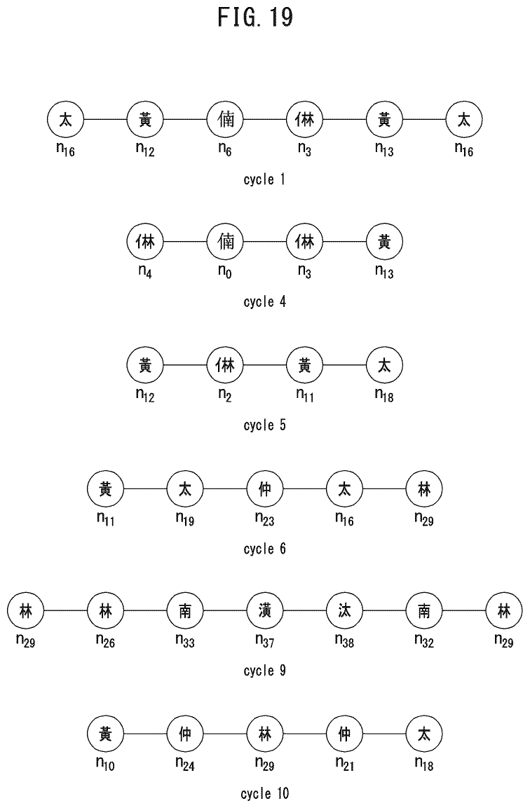

FIG. 19 is a diagram illustrating that information on cycles actually appears in Taryong music data during topological data analysis performed by a music data analysis apparatus according to an exemplary embodiment of the present disclosure.

Referring to FIG. 19, among the 10 cycles shown in FIG. 18, 6 cycles actually appearing consecutively in time within music data are shown.

FIGS. 20A to 20C are graphs illustrating a distribution of cycles appearing in Taryong music data, overlap matrix, and a distribution of nodes appearing in Taryong music data within a cycle, which are obtained during the process of topological data analysis performed by a music data analysis apparatus according to an exemplary embodiment of the present disclosure.

Referring to FIG. 19 and the upper part of FIG. 20A, it can be seen that Cycles 1, 4, 5, 6, 9, and 10 appear in actual music. The upper part of FIG. 20A is illustrated according to a concept similar to the upper part of FIG. 16A and the graph of FIG. 8. The upper part of FIG. 20A shows a case in which all nodes of a cycle appear in a time-sequentially continuous form in actual music. Referring to FIG. 19, it can be seen that in Cycles 1 and 9, closed cycles appear due to a circulation of the nodes.

In the lower part of FIG. 20A, a 4-scale overlap matrix for Taryong is shown. Since the lower part of FIG. 20A is illustrated according to a concept similar to that of FIG. 16A and FIG. 11, cycles (four or more nodes of each cycle) appear more frequently in the lower part of FIG. 20A than the upper part of FIG. 20A.

Cycle 2 does not appear even in the lower part of FIG. 20A. Also, as mentioned above, it can be seen that Taryong includes more cycles than Suyeonjang and Songkuyeo, but the frequency of actually appearing cycles is rarer than Suyeonjang and Songkuyeo.

FIGS. 20B and 20C show the number of cycles to which each node appearing in Taryong belongs. FIGS. 20B and 20C are illustrated according to a concept similar to FIGS. 16B and 16C and FIG. 13. Among the 40 nodes appearing in Taryong, the number of nodes included in a cycle more than once is 26.

Table 1 below compares the results of topological data analysis on Suyeonjang, Songkuyeo, and Taryong.

TABLE 1

| | | | | Occur- | | |
|---|---|---|---|---|---|---|
| | # of | Average | Average | rence/ | Dense- | Overlap |
| | cycles | node # | weight | Cycle | ness | (%) |
| Suyeonjang | 8 | 4.625 | 9.39375 | 1.125 | 0.09489 | 36.23188 |
| Songkuyeo | 8 | 5.375 | 7.84125 | 0.625 | 0.10153 | 32.05128 |
| Taryong | 10 | 4.8 | 4.385 | 0.7 | 0.03194 | 0 |

In Table 1, the number of cycles appearing in Suyeonjang, Songkuyeo, and Taryong, the average number of nodes included in cycles, average of weights of edges appearing in cycles, total number of occurrences of cycles/number of cycles, denseness, and overlap ratio (%) are shown.

The denseness may be defined as Ac/Af. Here, Ac may be an area occupied by cycles appearing in the 4-scale overlap matrix graph, and Af may be a total area of the corresponding graph. It can be seen that the denseness of Suyeonjang and Songkuyeo is about three times that of Taryong.

In addition, in the case of the 4-scale overlap matrix graph, the cycles appear to be non-overlapping in nature, and if this is indexed, the overlap ratio may be expressed as Ns/Nc×100 [%]. Here, Ns may be the number of times that two or more cycles appear simultaneously, and Nc may be the number of times that cycles appear in a time sequence of the music flow.

In the 4-scale overlap matrix graph, the overlap ratios of 36.2318% (Suyeonjang), 32.05128% (Songkuyeo), and 0% (Taryong) are shown.

Through topological data analysis, it can be seen that repetitive and cyclical patterns appear more frequently in Suyeonjang and Songkuyeo than in Taryong. These patterns match well with the characteristics of a pattern called ‘Dodeuri’. Dodeuri is known to have the meaning of ‘repeat-and-return’.

In the above, by applying the persistent homology theory of topological data analysis, a period having persistence was derived as a cycle from music data, and it was confirmed that each cycle corresponds to a cyclical and repetitive pattern of music data. In addition, it was shown that a frequency and time distribution of cycles coincided with cyclical and repetitive patterns of music and the intuitive sense of structural information of the music. As described above, the topological data analysis of the present disclosure can provide structural information on patterns of music data and guidance on interpretation of basic principles that appear during music creation, and based on this, when attempting to create or compose new music, a user may be supported to generate music based on the basic principles of music creation.

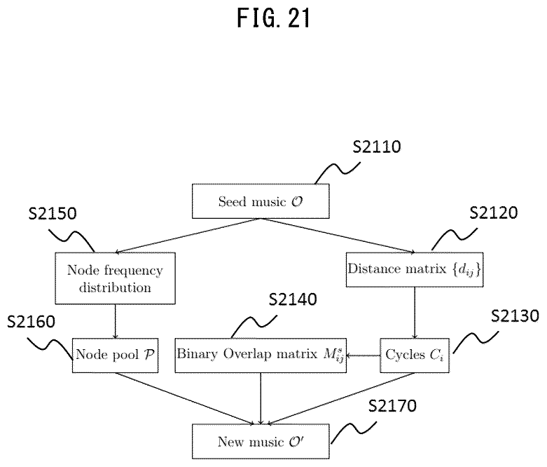

FIG. 21 is an operational flowchart illustrating a music data generation method performed by a music data generation apparatus according to an exemplary embodiment of the present disclosure.

Referring to FIG. 21, the music data generation apparatus may receive seed music data O (S2110).

The music data generation apparatus may define nodes and edges from a distribution of notes for the seed music data O, and generate a distance matrix {d₀} based on distances between the nodes (S2120). The node may correspond to a pitch and length of each note in the seed music data O, and the edge may be defined between nodes.

The music data generation apparatus may extract cycle information Ci by performing topological data analysis on the seed music data O (S2130).

The music data generation apparatus may generates a seed overlap matrix representing the musical features of the seed music data O based on the cycle information Ci (S2140).

The music data generation apparatus may generate new music data O′ based on the seed overlap matrix (S2170). In this case, according to exemplary embodiments of the present disclosure, the music data generation apparatus may generate the new music data O′ based on the seed overlap matrix, the cycle information Ci, and a node pool P.

The process of generating the new music data by the music data generation apparatus (S2170) may be performed according to two exemplary embodiments. In the first exemplary embodiment of the step S2170, after the music data generation apparatus generates nodes corresponding to pitches and lengths of the notes within the seed music data, the music data generation apparatus may obtain the cycle information and the seed overlap matrix, and may generate the new music data using the seed overlap matrix.

The music data generation apparatus may generate new music data by arranging nodes at position(s) of one or more first notes within the new music data according to a rule of the seed overlap matrix. Even in the process of arranging nodes to follow the rule of the seed overlap matrix, randomness may exist within the rule. For example, even if either a node n5 or n6 is placed in a specific situation, the node n5 or n6 may be randomly placed if the rule of the seed overlap matrix are met.

In addition to the one or more first notes in which nodes conforming to the rule of the seed overlap matrix are arranged, there may be positions of notes that have not yet been filled. For example, there may be positions of notes that are not defined by the rule of the seed overlap matrix.

The music data generation apparatus may generate the new music data by arranging nodes probabilistically extracted from the node pool P at positions of one or more second notes not yet filled in the new music data.

The music data generation apparatus may adjust the distribution of nodes based on a target length of and a target frequency at which nodes appear in a state in which the nodes are defined (S2150) to generate the node pool P (2160). The process of generating the node pool (S2160) may be performed based on the frequency of nodes appearing on seed music data in the state where the nodes are defined. The target length may be the number of notes of the new music data. That is, if 440 notes are to be arranged in the new music data to be composed, the target length may be 440. When a node is arranged in time and appears, it is expressed as a note. When positions corresponding to the target length exist and nodes are temporally disposed at the positions, the new music data including notes corresponding to the target length is generated.

The steps S2150 and S2160 may be executed independently of the steps S2120 to S2140. In this case, only information on the frequency of the nodes is used, and edge-related information is not considered in the steps S2150 and S2160. In the step S2150, for example, when the seed music data is Suyeonjang music data, appearing 33 nodes may be increased and overlapped to correspond to 440 notes which is the target length. In this case, in the node pool P finally composed of 440 notes, 33 nodes are arranged to appear according to the respective frequencies in the seed music data.

For example, if a node n0 appears with a frequency of 1/10, 44 positions, 1/10 of the 440 notes in the node pool, are filled with the node n0. In the process of arranging nodes probabilistically extracted from the node pool at the positions of one or more second nodes, the probability of extracting/arranging the node n0 is 1/10.

In this process, statistics on each node shown in FIG. 4 and the frequency of each node and may be used. In the case of using Suyeonjang music data as a seed, it can be seen that the node n18 appeared 76 times, the node n6 appeared 57 times, and the nodes n11 and n22 appeared 44 times from among of 440 notes. When desiring to form a node pool containing 440 nodes, if the node pool is formed so that the node n18 overlaps 76 times, the node n6 overlaps 57 times, and each of the nodes n11 and n22 overlap 44 times within the node pool, the frequency of each node within the node pool may be kept consistent with the frequency of appearance in the seed music data. The frequency of appearance of each node in the node pool may be defined as in Equation 3 below.

$$Node probability of {n}_{j} = \frac{Node frequency of {n}_{j}}{Total number of node frequencies} \qquad [ Equation 3 ]$$

Here, the node nⱼ means the j-th node.

In an exemplary embodiment of the present disclosure, the seed overlap matrix may be defined as a binary matrix as shown in Equation 2 above. In this case, if the expression representing the seed overlap matrix is rewritten, it is equivalent to Equation 4.

$${m}_{ij}^{s} = \{ \begin{matrix}1 , & if ∃ t , l \geq 0 satisfying t + l \geq s - 1 such that \\ & {n}_{j - l} , {n}_{j - l - 1} , … , {n}_{j} , … , {n}_{j + t - 1} , {n}_{j + t} ∈ {C}_{i} , \\ 0 , & otherwise ,\end{matrix} \qquad [ Equation 4 ]$$

Equation 4 above may be defined for i=1, . . . , k, and j=1, . . . , d.

In the seed overlap matrix M_{k×d}^{s} obtained as a result of the topological data analysis process on the seed music data, k is the number of cycles, and d is the total number of notes in the music data to be analyzed. The case where the seed overlap matrix H satisfies s-scale may be described by Example 1 below.

### EXAMPLE 1

m_{i,j-l}^{s}=m_{i,j-t-1}^{s}= . . . =mᵢⱼ^{s}= . . . =m_{i,j+t-1}^{s}=m_{i,j+t}^{s}=1.

Notice that there are t+l+1 entries from m_{i,j-l}^{s} to m_{i,j+t}^{s}:

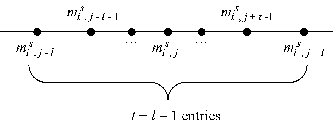

According to an exemplary embodiment of the present disclosure, when the total number of notes of the seed music data is defined as d=440, the target length of new music data to be generated may also be defined as d=440. In this case, Equation 4 may be used as an overlap matrix for generating new music data.

According to another exemplary embodiment of the present disclosure, when the total number of notes of the seed music data is defined as d=440, the target length of the new music data to be generated may be set to a multiple of d. In this case, an overlap matrix for generating the new music data may be generated by duplicating the seed overlap matrix given by Equation 4.

Despite the above-described exemplary embodiments, the total number d of notes in the seed music data and the target length of the new music data to be generated do not necessarily need to be the same. Therefore, the spirit of the present disclosure should not be limited to or reduced to these exemplary embodiments.

In another exemplary embodiment of the present disclosure, the seed overlap matrix may be defined as an integer overlap matrix. A process of calculating the integer overlap matrix may be exemplarily implemented by a pseudo-code shown in Example 2 below.

### EXAMPLE 2

Algorithm to compute integer Overlap matrix on s-scale M_{k×d}^{s}

```
Given [symbol]     and Cycle information C₁, . . . , Cₖ.
Set M_{k×d}^{s} = [symbol]    _{k×d} (zero matrix).
Let j = 1.
For each row i = 1, . . . , k, repeat the followings until j = d.
Step 1: Find
          $q = {arg min}_{β} \{ j \leq β \leq d : {n}_{β} ∈ {𝒞}_{i} \} . \qquad ( 2 )$
      if (2) has no solution, then
        break
      else go to Step 2.
Step 2: Find
          $r = {arg min}_{γ} \{ q < γ \leq d : {n}_{γ} ∉ {𝒞}_{i} \} . \qquad ( 3 )$
      if (3) has no solution, then
        if d − q ≥ s − 1, then
          m_{i,j}^{s} = nⱼ, j = q, . . . , d.
        break
      else if (3) has a solution and r − q ≥ s, then
          m_{i,j}^{s} = nⱼ, j = q, . . . r − 1.
Set j = r and come back to Step 1.
```

The integer overlap matrix may be expressed as in Equation 5 below.

$${m}_{ij}^{s} = \{ \begin{matrix}{n}_{j} , & if ∃ t , l \geq 0 satisfying t + l \geq s - 1 such that \\ & {n}_{j - l} , {n}_{j - l - 1} , … , {n}_{j} , … , {n}_{j + t - 1} , {n}_{j + t} ∈ {C}_{i} , \\ 0 , & otherwise ,\end{matrix} \qquad [ Equation 5 ]$$

Equation 5 above may be defined for i=1, . . . , k, and j=1, . . . , d.

In the integer overlap matrix, a non-zero entry is not fixed to 1 and may be represented by one of nodes of a continuous sequence.

Unlike the one or more first notes to which the overlap matrix rule is applied in the first exemplary embodiment of the step S2170, the overlap matrix rule may not be 100% satisfied for the one or more second notes, but according to this exemplary embodiment, the spirit of the present disclosure should not be construed as limiting or narrowing.

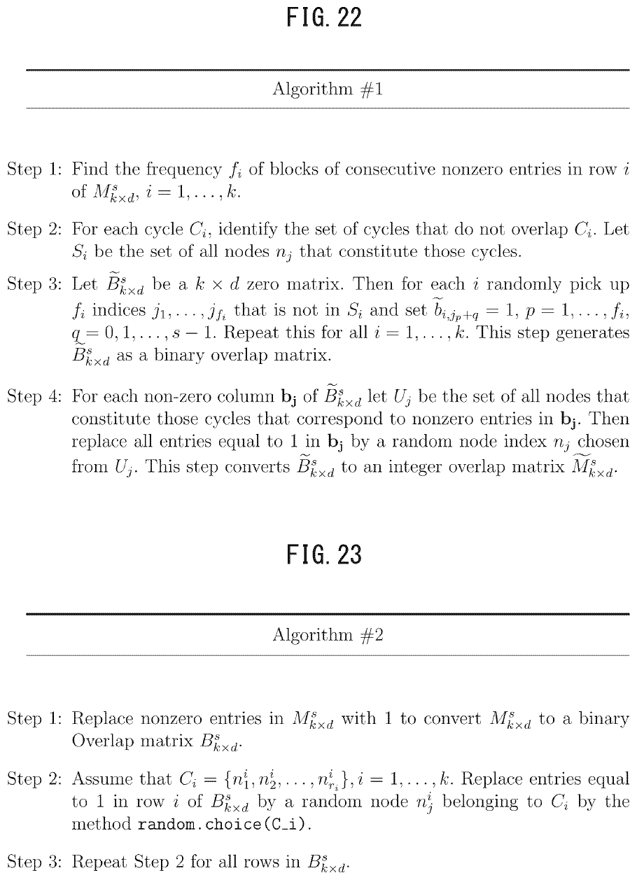

The second exemplary embodiment of the step S2170 using an artificial neural network will be described with reference to FIGS. 22, 23 and 28 to be described later. In the second exemplary embodiment, the overlap matrix rule and the seed music data are given as inputs to the artificial neural network. Depending on a training process of a generative artificial neural network, the degree to which the new music data according to the second exemplary embodiment satisfies the overlap matrix rule may be higher than that of the first exemplary embodiment.

FIGS. 22 to 24 are diagrams illustrating a process of generating an integer overlap matrix, which is performed in a music data generation apparatus according to an exemplary embodiment of the present disclosure.

For example, if an s-scale integer overlap matrix obtained by using Suyeonjang music data as the seed music data is denoted as M_{k×d}^{s}, an integer overlap matrix \tilde{M}_{k×d}^{s} having the same size as the overlap matrix M_{k×d}^{s} and having similar patterns may be generated. Three algorithms that can generate the integer overlap matrix \tilde{M}_{k×d}^{s} will be described in FIGS. 22 to 24.

Referring to FIG. 22, a frequency of a block of consecutive non-zero entries in each row i, corresponding to k cycles, may be obtained. For each cycle Ci, a set of cycles that do not overlap with the cycle Ci is identified, and a set of nodes of the identified cycles is configured as Si. A zero matrix having the same size as the overlap matrix, k×d, is configured, and a binary overlap matrix having 0 or 1 entries is generated based on a distribution of the integer overlap matrix. The integer overlap matrix \tilde{M}_{k×d}^{s} is generated by replacing the entry 1 of the generated binary overlap matrix with a random node index nj.

Referring to FIG. 23, the binary overlap matrix is generated by replacing all non-zero entries of the integer overlap matrix with 1. The process of replacing entry 1 with a random node using a random.choice(Ci) function for each row i of the binary overlap matrix may be repeated for all rows to generate the integer overlap matrix

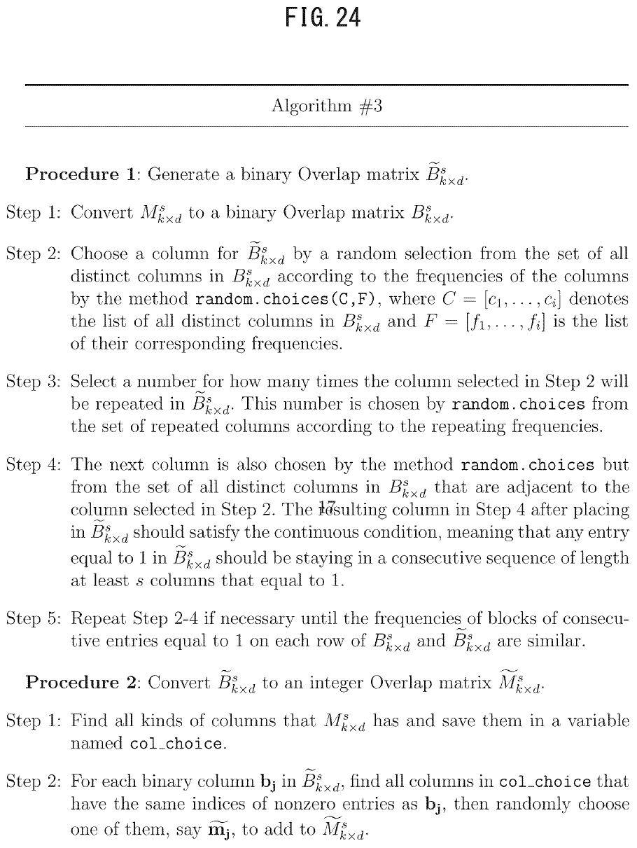

Referring to FIG. 24, after converting the integer overlap matrix M_{k×d}^{s} into the binary overlap matrix, the integer overlap matrix \tilde{M}_{k×d}^{s} may be generated by randomly selecting columns of the binary overlap matrix, assigning random values based on the frequency of occurrence of non-zero entries, and converting the integer overlap matrix.

In the case of using an artificial neural network in the step S2170 of FIG. 21, the integer overlap matrix M_{k×d}^{s} or the randomized integer overlap matrix \tilde{M}_{k×d}^{s} may be used in an exemplary embodiment of the present disclosure.

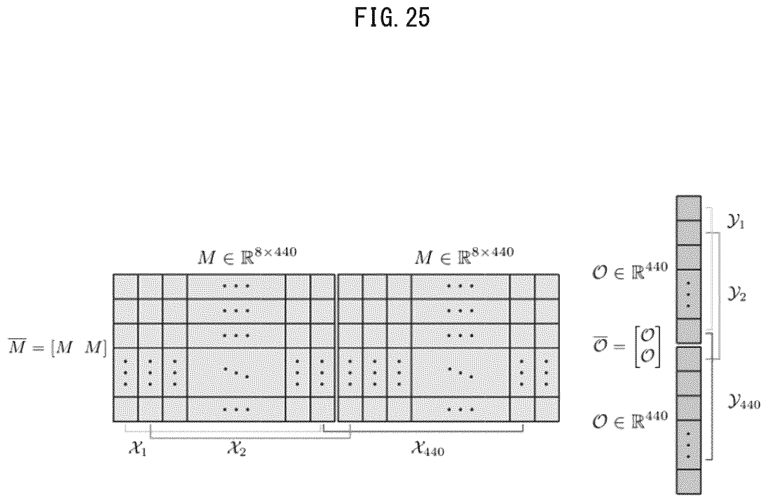

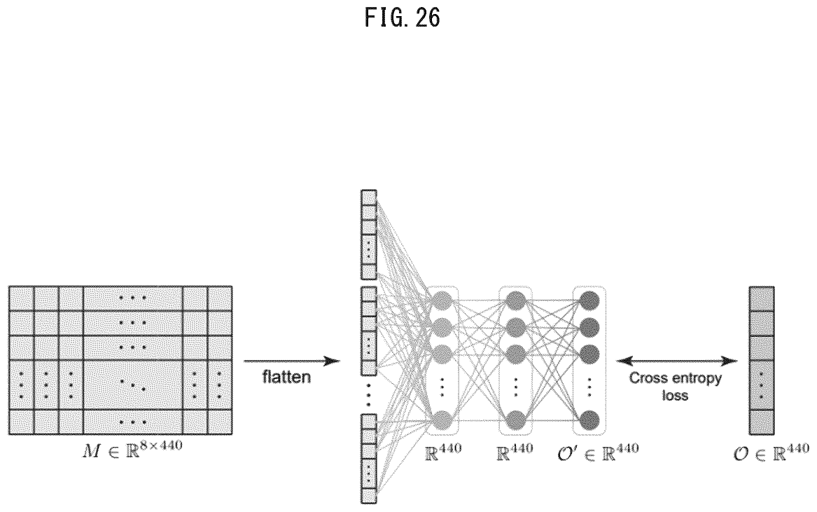

FIGS. 25 and 26 are diagrams illustrating a process of generating music data using an artificial neural network, which is performed in a music data generation apparatus according to an exemplary embodiment of the present disclosure.

Referring to FIG. 25, for training of the artificial neural network, seed music data may be constructed as

$$\overline{𝒪} = [ \begin{matrix}𝒪 \\ 𝒪\end{matrix} ] ,$$

and the overlap matrix M may be constructed as M̅32 [M M] in order to generate a training data set.

Referring to FIG. 26, the artificial neural network may take a flattened vector of data belonging to the training dataset, and pass it through two hidden layers having 440 nodes. The new music data O′ may be a 440-dimensional column vector having 440 elements selected from 33 nodes. A parameter vector of the artificial neural network may be updated to minimize a cross entropy between the column vector of the training dataset and the new music data O′.

The composition process by the artificial neural network may be performed by finding a parameter θ* that maximizes a probability for the actual music data L and the integer overlap matrix M_{k×d}^{s}. This process may be represented by Equation 6 below.

$${θ}^{*} = {argmax}_{θ} {\sum }_{( {ℒ}^{( i )} , {M}^{( i )} )} log p ( {ℒ}^{( i )} \vert {M}^{( i )} ) \qquad [ Equation 6 ]$$

The function argmax (f(x)) is a function for obtaining x that maximizes f(x), θ is a parameter of the artificial neural network model, and ( [symbol] ⁽ⁱ⁾, M⁽ⁱ⁾) is the i-th pair of the music data L and the overlap matrix M derived from the music data L. In constructing an artificial neural network model, a conditional probability distribution p may be modeled using a Multi-Layer Perceptron (MLP), but an arbitrary nonlinear function may be used instead. The MLP may be regarded as a sequence of affine transformations subject to element-wise nonlinearity. If the j-th hidden layer of the MLP is f(j), a column vector a(j) corresponding to a dimension d(j) of f(j) may be defined.

An output of f(j), which is obtained by receiving an output a(j−1) of the previous layer f(j−1) and performing calculation of the artificial neural network, is represented by Equation 7 below.

f(j)[a(j−1)]=σ[W(j)a(j−1)+b(j)] [Equation 7]

W(j) is a learnable weight matrix of size d(j)*d(j−1), b(j) is a bias vector as a column vector corresponding to the dimension d(j), and the nonlinear function σ is a function applied to each element of the vector. Each hidden layer may use a different activation function. As a typical selection of the nonlinear function σ, a sigmoid function, a hyperbolic tangent function, and a Rectified Linear Unit (ReLU) may be used.

A general MLP takes a vector as an input. Since the output derived in the present disclosure is a matrix, a means of flattening a matrix into a one-dimensional vector may be adopted as the simplest method for inputting the matrix into the MLP. The artificial neural network fθ of the present disclosure may take a flattened vector of M(i) and output d probability distributions for individual q notes.

In this case, the artificial neural network of the present disclosure outputs a dq-dimensional vector, which is reshaped into a d*q matrix [symbol] and a softmax function may be performed for each row. The output of the artificial neural network model for the overlap matrix M(i) is represented by Equation 8 below.

$${\hat{ℒ}}_{jk}^{( i )} = \frac{exp ( {a}_{q ( j - 1 ) + k}^{( L )} )}{{\sum }_{l = 1}^{q} exp ( {a}_{q ( j - 1 ) + l}^{( L )} )} \qquad [ Equation 8 ]$$

[symbol]

may be interpreted as a probability that the j-th note in the generated music data is Nk, and a(L) is the output of the last hidden layer. The parameters of the artificial neural network of the present disclosure may be updated to minimize a cross entropy loss between the output probability distribution [symbol] and the actual music data [symbol] , and the process is represented by Equation 9 below.

$$CrossEntropyLoss ( {\hat{ℒ}}^{( i )} , {ℒ}^{( i )} ) = - \frac{1}{d} {\sum }_{j = 1}^{d} {\sum }_{k = 1}^{q} {ℒ}_{jk}^{( i )} log {\hat{ℒ}}_{jk}^{( i )} \qquad [ Equation 9 ]$$

In this case, if the j-th note is equal to Nₖ,=1, [symbol] =1, and [symbol] =0 otherwise d and q corresponding to the size d*q of [symbol] are included in Equation 9.

In the experimental example of the present disclosure, Equation 9 was optimized using an Adam optimizer in relation to the artificial neural network of the present disclosure, and was optimized at a learning rate of 0.001 over 500 epochs.

In the experimental example of the present disclosure, d(1)=d(2)=440 in the first hidden layer and the second hidden layer, and the ReLU function was used as the nonlinear function σ. In the third hidden layer, d(3)=440×33, and the softmax function of Equation 8 was used as the nonlinear function σ.

FIG. 27 is a block diagram illustrating components constituting a music data analysis apparatus or a music data generation apparatus according to an exemplary embodiment of the present disclosure. The music data analysis apparatus or the music data generation apparatus may be a kind of computing system 1000 shown in FIG. 27 and may include the following internal components.

Referring to FIG. 27, the computing system 1000 in which the music data analysis apparatus or music data generation apparatus according to an exemplary embodiment of the present disclosure is implemented may include a processor 1100, a memory 1200, a communication interface 1300, an input interface device 1400, an output interface device 1500, a storage device 1600, and a bus 1700.

The computing system 1000 in which the music data analysis apparatus or music data generation apparatus according to an exemplary embodiment of the present disclosure is implemented may include at least one processor 1100 and a memory 1200 for storing instructions instructing the processor 1100 to perform at least one step.

The processor 1100 may mean a central processing unit (CPU), a graphics processing unit (GPU), or a dedicated processor on which methods according to the exemplary embodiments of the present disclosure are performed.

Each of the memory 1200 and the storage device 1600 may include at least one of a volatile storage medium and a non-volatile storage medium. For example, the memory 1200 may include at least one of a read only memory (ROM) and a random access memory (RAM).

Further, the computing system 1000 in which the music data analysis apparatus or music data generation apparatus is implemented may include a communication interface 1300 that performs communication through a wireless or wired network.

Further, the computing system 1000 in which the music data analysis apparatus or music data generation apparatus is implemented may further include the input interface device 1400, the output interface device 1500, the storage device 1600, and the like.

Further, the respective components included in the computing system 1000 in which the music data analysis apparatus or music data generation apparatus is implemented may communicate with each other by being connected through the bus 1700.

For example, the computing system 1000 in which the music data analysis apparatus or music data generation apparatus is implemented may be a desktop computer, laptop computer, notebook, smart phone, tablet PC, mobile phone, smart watch, smart glasses, e-book reader, portable multimedia player (PMP), portable game machine, navigation device, digital camera, digital multimedia broadcasting (DMB) player, digital audio recorder, digital audio player, digital video recorder, digital video player, personal digital assistant (PDA), and/or the like having communication capability.

FIG. 28 is a block diagram illustrating components in a music data generating apparatus according to an exemplary embodiment of the present disclosure.

Among the components included in the music data generation apparatus of FIG. 28, some of the components shown in FIG. 27 are omitted for brief description. The processor 1100 of FIG. 28 may be connected to an artificial neural network 1250 via the bus 1700. A weight matrix constituting the artificial neural network 1250 may be stored in the memory 1200 and/or the storage device 1600, and activation parameters generated during operations of the artificial neural network may be stored in the memory 1200 and/or the storage device 1600.

The weights and activation parameters constituting the artificial neural network 1250 may be stored in a separate device (not shown) other than the memory 1200 and/or the storage device 1600, and the artificial neural network 1250 may be operated under the control of the processor 1100. The operations of the artificial neural network may include data input/output and logical/arithmetic operations between the processor 1100 and the artificial neural network 1250, which are performed during a process of generating new music data from the seed overlap matrix and a training process of training the process of generating new music data from the seed overlap matrix.

The artificial neural network 1250 may be a generative artificial neural network, and may be an artificial neural network having learned the process of generating new music data from the seed overlap matrix. The artificial neural network 1250 may generate new music data when the seed overlap matrix is given as an input. In this case, the artificial neural network 1250 may be an artificial neural network having learned the process of generating new music data by receiving the seed overlap matrix and seed music data. The artificial neural network 1250 may generate new music data when the seed overlap matrix and seed music data are given as inputs. The process of training the artificial neural network 1250 and generating new music data may be performed under the control of the processor 1100.

Referring to FIGS. 1 to 28, the exemplary embodiment of the present disclosure may analyze and reconstruct a musical score of Korean traditional music into a music network, and visualize musical characteristics of the Korean traditional music using a topological data analysis method.

An exemplary embodiment of the present disclosure can compose new Korean music that follows the rules of the Dodeuri pattern of Korean traditional music, or provide a user interface (UI) that supports a user to compose the Korean traditional music.

An exemplary embodiment of the present disclosure can compose new music in which structural characteristics of a specific genre appear by using an artificial neural network for the specific genre whose structural characteristics are known according to a topological data analysis on music or by a rule-based method/algorithm, or provide a UI that supports a user to compose the new music.

An exemplary embodiment of the present disclosure can provide a UI that supports playing a creative song through a virtual musical instrument.

An exemplary embodiment of the present disclosure can provide a UI that supports a user to compose music by interacting with an application program and visualizing music or by directly inputting an overlap matrix drawn as a picture.

An exemplary embodiment of the present disclosure can probabilistically define a visualization model, learn a mathematical expression of music, and compose music by the artificial intelligence or an algorithm.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A music data analysis apparatus comprising:
a memory; and
a processor executing at least one instruction stored in the memory,
wherein the processor is configured to:
transform music data to a network including nodes and edges;
obtain cycle information by applying topological data analysis to the transformed network; and
generate an overlap matrix representing musical features of the music data by calculating a distribution of cycles included in the cycle information.

2. The music data analysis apparatus according to claim 1, wherein the processor is further configure to visualize the musical features of the music data based on the overlap matrix.

3. The music data analysis apparatus according to claim 1, wherein in the obtaining of the cycle information, the processor is further configured to:
apply a persistent homology theory linked to topological data analysis to the network to generate persistence barcode information; and
obtain the cycle information corresponding to patterns appearing within the music data by applying topological data analysis to the persistent barcode information.

4. The music data analysis apparatus according to claim 1, wherein in the generating of the overlap matrix, the processor is further configured to: calculate the distribution of the cycles appearing in s consecutive sequences to generate the overlap matrix.

5. The music data analysis apparatus according to claim 1, wherein the processor is further configured to:
generate the nodes corresponding to notes appearing in the music data, and configuring a pitch and a length of each corresponding note in each node as information of the each node; and
set an edge between the nodes, and setting a frequency of the nodes appearing at a same time or adjacent time as information of the edge.

6. The music data analysis apparatus according to claim 1, wherein the processor is further configured to: extract a pattern repeatedly appearing within the music data as the cycle. 7 A music data generation apparatus comprising:
a memory; and
a processor executing at least one instruction stored in the memory,
wherein the processor is configured to:
generate a seed overlap matrix so that the seed overlap matrix represents musical features of seed music data; and
generate new music data based on the seed overlap matrix.

8. The music data generation apparatus according to claim 7, wherein the processor is further configured to:
generate nodes each of which corresponds to a pitch and a length of a corresponding note within the seed music data; and
generate the new music data by arranging the nodes at position(s) of at least one first note in the new music data to conform to a rule of the seed overlap matrix.

9. The music data generation apparatus according to claim 8, wherein the processor is further configured to:
generate a node pool by overlapping the nodes based on a frequency of occurrence of the nodes and a target length; and
generate the new music data by arranging nodes extracted based on probabilities from the node pool at position(s) of at least one second note in the new music data.

10. The music data generation apparatus according to claim 7, further comprising a generative artificial neural network having learned generative functions, which is stored in at least one of the memory or a data base, wherein the processor is further configured to:
control the generative artificial neural network so that the seed overlap matrix is input to the generative artificial neural network; and
control the generative artificial neural network so that the generative artificial neural network generates the new music data using the seed overlap matrix as an input.

11. A music data analysis method performed by a processor executing at least one instruction stored in a memory, the music data analysis method comprising:
transforming music data to a network including nodes and edges;
obtaining cycle information by applying topological data analysis to the transformed network; and
generating an overlap matrix representing musical features of the music data by calculating a distribution of cycles included in the cycle information.

12. The music data analysis method according to claim 11, further comprising: visualizing the musical features of the music data based on the overlap matrix.

13. The music data analysis method according to claim 11, wherein the obtaining of the cycle information further comprises:
applying a persistent homology theory linked to topological data analysis to the network to generate persistence barcode information; and
obtaining the cycle information corresponding to patterns appearing within the music data by applying topological data analysis to the persistent barcode information.

14. The music data analysis method according to claim 11, wherein the generating of the overlap matrix further comprises: calculating the distribution of the cycles appearing in s consecutive sequences to generate the overlap matrix.
